(19) United States
(12) Patent Application Publication
(10) Pub. No.: US 2004/0153567 A1
(43) Pub. Date: Aug. 5, 2004

(54) Scheduling data transfers using virtual nodes

(76) Inventor: Walter D. Lichtenstein, Belmont, MA (US)

Correspondence Address: Burt Magen, Esq., Vierra Magen Marcus Harmon & DeNiro, LLP, Suite 540, 685 Market Street, San Francisco, CA, 94105-4206, US

(21) Appl. No.: 10/356,714

(22) Filed: Jan. 31, 2003

(51) Int. Cl. G06F 15/16

(52) U.S. Cl. 709/235; 709/219

(57) ABSTRACT

The present invention is directed to technology for employing one or more virtual nodes in a communications network to schedule data transfers. A virtual node receives a scheduling request for a transfer of data from a first node in the network to a second node in the network. The virtual node determines whether sufficient resources exist at the first node for performing the data transfer. In some instances, the virtual node creates a schedule for making the transfer, and the second node employs the schedule to reserve bandwidth for receiving the future transfer. In further embodiments, the virtual node arranges for the requested data to be delivered to the first node, so the first node's scheduled data transfer to the second node can be performed.

### CROSS-REFERENCE TO RELATED APPLICATIONS

This Application is related to the following Applications:

U.S. patent application Ser. No. 09/853,816, entitled “System and Method for Controlling Data Transfer Rates on a Network,” filed May 11, 2001;

U.S. patent application Ser. No. 09/935,016, entitled “System and Method for Scheduling and Executing Data Transfers Over a Network,” filed Aug. 21, 2001;

U.S. patent application Ser. No. 09/852,464, entitled “System and Method for Automated and Optimized File Transfers Among Devices in a Network,” filed May 9, 2001; and

U.S. patent application Ser. No.______, entitled “Scheduling Data Transfers for Multiple Use Requests,” Attorney Docket No. RADI-01000US0, filed on the same day as the present application.

Each of these related Applications is incorporated herein by reference.

### BACKGROUND OF THE INVENTION

1. Field of the Invention

The present invention is directed to technology for scheduling transfers in a communications network.

2. Description of the Related Art

The growing use of communications networks has created increased demands for access to network bandwidth. Network users want to transfer large volumes of data through communications networks for local use. Corporate records and documentation shared by employees in multiple geographic locations provide examples of such data. Entertainment media, such as a digital movie file, provides another example.

In order to meet user demands, network resources, such as servers, must simultaneously service many different requests for data from many different entities. In traditional networking environments, network resources attempt to provide this service without fully evaluating the many network variables that come into play. These variables can include the acceptable window of delivery for requested data, bandwidth available at data receivers, bandwidth available at data senders, and bandwidth available at intermediary network resources that carry data between senders and receivers. Failing to consider these resources can result in an inefficient use of network bandwidth.

An inability to detect and manage network bottlenecks can arise from a lack of coordination between network resources. A path between a sending network node and a receiving network node may include several intermediary nodes. These intermediaries may not have the capacity to work with the receiver and sender to efficiently coordinate a data transfer schedule. This leaves many of the above-identified network variables unconsidered for the portion of the data path passing through the intermediaries. As a result, the intermediaries may become oversubscribed by a combination of demands from the sender, receiver, and other network entities—wasting network bandwidth and potentially causing data to go undelivered.

### SUMMARY OF THE INVENTION

The present invention, roughly described, pertains to technology for managing a potential communications network bottleneck through the use of virtual nodes.

In one embodiment of the present invention, a communications network includes member nodes that schedule data transfers using network related variables. In one implementation, these variables include acceptable windows of delivery for requested data, bandwidth available at data receivers, bandwidth available at data senders, and bandwidth available at intermediary network resources. The network also includes one or more non-member nodes that do not employ these variables when scheduling data transfers.

Virtual nodes in the network facilitate the transfer of data through non-member nodes. The virtual nodes perform data transfer scheduling for the non-member nodes, using the same network variables as the member nodes. In one embodiment, non-member nodes utilize data transfer schedules from virtual nodes to perform data transfers like a member node. In further embodiments, other member nodes utilize the virtual node schedules to determine whether a data transfer can pass through one or more non-member nodes. The operation of the virtual nodes enables the communications network to manage and avoid potential bottlenecks that may form in network paths including non-member nodes.

In one embodiment, a virtual node receives an external scheduling request for a transfer of data from a non-member node. The virtual node determines whether sufficient transmission resources exist at the non-member node for transmitting the requested data. If sufficient resources exist, the virtual node sets a delivery schedule using the same scheduling criteria and process employed by member nodes. In one implementation, the virtual node instructs the non-member node to reserve bandwidth for transmitting the data according to the schedule. In an alternate implementation, the virtual node does not communicate with the non-member node, but the node requesting the transfer is informed that sufficient bandwidth exists.

If the non-member node does not have the requested data, the virtual node also arranges for delivery of the requested data to the non-member node. After the data is available, the non-member node transmits the data when it is requested. In embodiments where the virtual node communicates with the non-member node, the non-member node performs the data transfer according to a bandwidth schedule provided by the virtual node.

The present invention can be accomplished using hardware, software, or a combination of both hardware and software. The software used for the present invention is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers.

These and other objects and advantages of the present invention will appear more clearly from the following description in which the preferred embodiment of the invention has been set forth in conjunction with the drawings.

### BRIEF DESCRIPTION OF THE DRAWINGS

FIG. 1 is block diagram of a communications network in which embodiments of the present invention can be employed.

FIG. 2 is a block diagram representing a data transfer in accordance with one embodiment of the present invention.

FIG. 3 is a block diagram representing a data transfer to multiple nodes in accordance with one embodiment of the present invention.

FIG. 4 is a block diagram representing a data transfer through a potential bottleneck formed by nodes E and F.

FIG. 5 is a block diagram representing a data transfer though the potential bottleneck formed by nodes E and F, using virtual nodes VE and VF in accordance with one embodiment of the present invention.

FIG. 6 is a block diagram of a communications network including virtual nodes VE and VF.

FIG. 7 is a block diagram of network nodes operating as senders, intermediaries, and receivers in one implementation of the present invention.

FIGS. 8A-8D are block diagrams of different transfer module configuration employed in embodiments of the present invention.

FIG. 9 is a flowchart describing one embodiment of a process for servicing a data transfer request.

FIG. 10 is a flowchart describing one embodiment of a process for providing a soft rejection.

FIG. 11 is a flowchart describing one embodiment of a process for determining whether a data transfer request is serviceable.

FIG. 12 is a flowchart describing one embodiment of a process for servicing a scheduling request.

FIG. 13A is a block diagram of a scheduling module in one implementation of the present invention.

FIG. 13B is a block diagram of a scheduling module in an alternate implementation of the present invention

FIG. 13C is a block diagram of an admission control module in one implementation of the present invention.

FIG. 14 is a flowchart describing one embodiment of a process for determining whether sufficient transmission resources exist.

FIG. 15 is a set of bandwidth graphs illustrating the difference between flow through scheduling and store-and-forward scheduling.

FIG. 16 is a set of bandwidth graphs illustrating one example of flow through scheduling for multiple end nodes in accordance with one embodiment of the present invention.

FIG. 17 is a flowchart describing one embodiment of a process for generating a composite bandwidth schedule.

FIG. 18 is a flowchart describing one embodiment of a process for setting composite bandwidth values.

FIG. 19 is a graph showing one example of an interval on data demand curves for a pair of nodes.

FIG. 20 is a flowchart describing one embodiment of a process for setting bandwidth values within an interval.

FIG. 21 is a graph showing a bandwidth curve that meets the data demand requirements for the interval shown in FIG. 19.

FIG. 22 is a graph showing another example of an interval of data demand curves for a pair of nodes.

FIG. 23 is a graph showing a bandwidth curve that meets the data demand requirements for the interval shown in FIG. 22.

FIG. 24 is a flowchart describing one embodiment of a process for determining whether sufficient transmission bandwidth exists.

FIG. 25 is a flowchart describing one embodiment of a process for generating a send bandwidth schedule.

FIG. 26 is a graph showing one example of a selected interval of constraint and scheduling request bandwidth schedules.

FIG. 27 is a flowchart describing one embodiment of a process for setting send bandwidth values within an interval.

FIG. 28 is a graph showing a send bandwidth schedule based on the scenario shown in FIG. 26.

FIG. 29 is a graph showing another example of a selected interval of constraint and scheduling request bandwidth schedules.

FIG. 30 is a graph showing a send bandwidth schedule based on the scenario shown in FIG. 29.

FIG. 31 is a flowchart describing an alternate embodiment of a process for determining whether a data transfer request is serviceable, using proxies.

FIG. 32 is a flowchart describing one embodiment of a process for selecting data sources, using proxies.

FIG. 33 is a flowchart describing an alternate embodiment of a process for servicing data transfer requests when preemption is allowed.

FIG. 34 is a flowchart describing one embodiment of a process for servicing data transfer requests in an environment that supports multiple priority levels.

FIG. 35 is a flowchart describing one embodiment of a process for tracking the use of allocated bandwidth.

FIG. 36 is a block diagram depicting exemplar components of a computing system that can be used in implementing the present invention.

### DETAILED DESCRIPTION

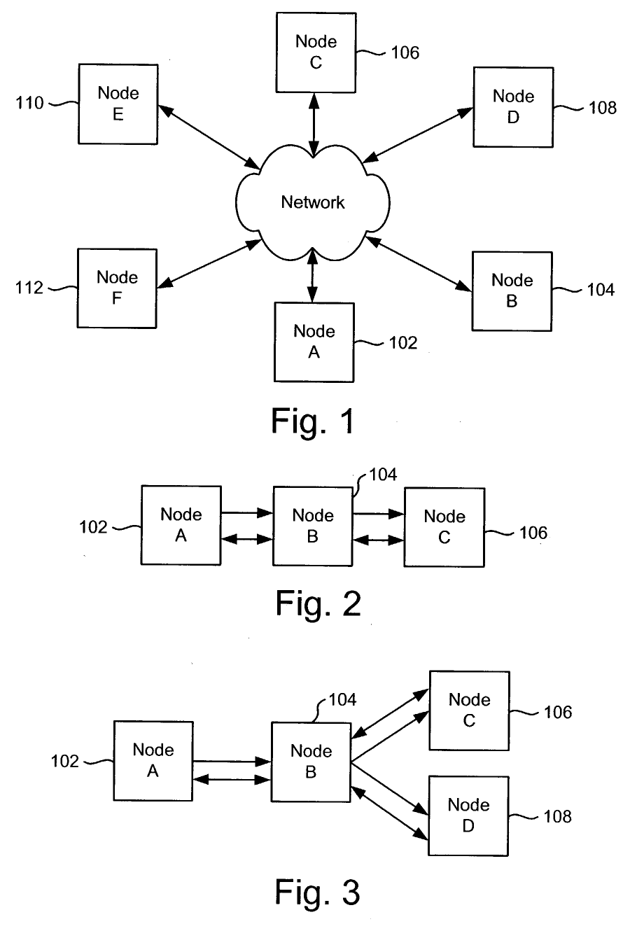

FIG. 1 is block diagram of a communications network in which embodiments of the present invention can be employed. Communications network 100 facilitates communication between nodes A 102, B 104, C 106, D 108, E 110, and F 112. Network 100 can be a private local area network, a public network, such as the Internet, or any other type of network that provides for the transfer of data and/or other information. In further embodiments, network 100 can support more or less nodes than shown in FIG. 1, including implementations where substantially more nodes are supported.

FIG. 2 represents one example of a data transfer that takes place between nodes according to one embodiment of the present invention. Node A 102 is providing data to node C 106 via node B 104. The nodes employ a common scheme for scheduling data transfers from node A to node B and node B to node C. In one implementation, the common scheme considers the following factors when data transfers are serviced: bandwidth required for receiving data at a node, bandwidth required for sending data from a node, and storage capacity for maintaining data at a node. During the scheduling process, nodes A, B, and C share scheduling information, as shown by the bi-directional arrows. The single direction arrows represent the flow of data in this data transfer. Greater details regarding a process for scheduling data transfers are provided below.

FIG. 3 represents another example of a data transfer operation taking place between nodes A, B, C, and D in accordance with the present invention. Nodes C and D have requested the same data from node B. Node B does not have the requested data but can obtain the data from node A. Node B generates a composite bandwidth schedule based on the requirements for delivering the requested data to nodes C and D. Node B then asks node A to provide the requested data at a rate that satisfies the composite bandwidth schedule. If possible, node A generates a send bandwidth schedule for delivering data to node B in a way that satisfies the composite bandwidth schedule. Greater details for carrying out scheduling in this multiple use request scenario are provided below.

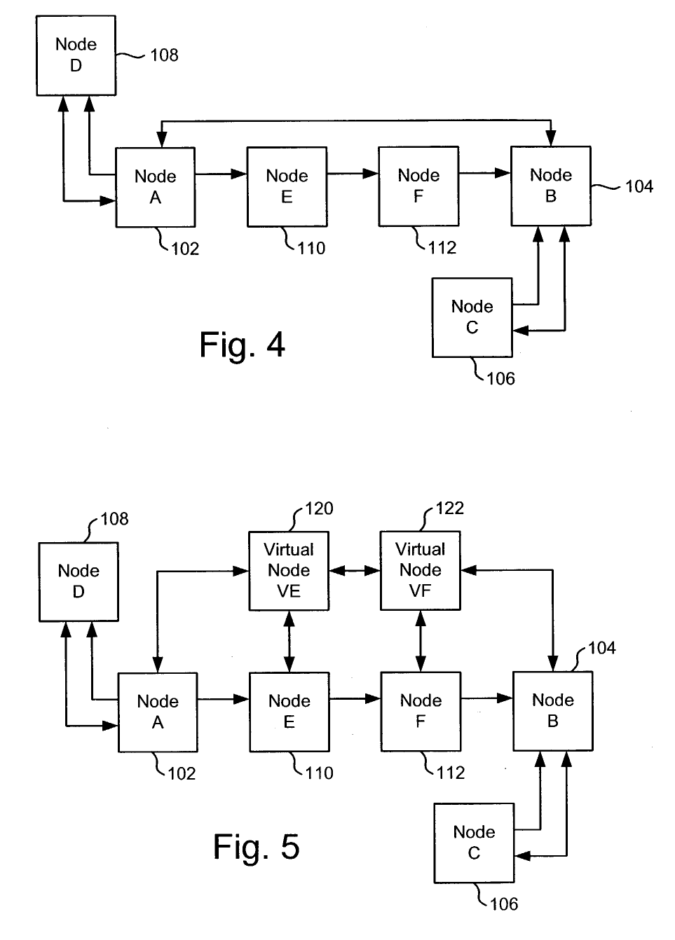

FIG. 4 represents a situation that occurs when data needs to flow through nodes that do not perform a common process for scheduling data transfers. Nodes A, B, C, and D are member nodes that perform a common scheduling process in accordance with the present invention. Nodes E and F do not perform the same scheduling process—making them non-member nodes. As seen in FIG. 4, there is no bidirectional flow of scheduling information between nodes E and F and the other nodes.

Without sharing scheduling information, nodes E and F may become oversubscribed. In the example shown in FIG. 4, Node B requests data from nodes A and C. Node A schedules delivery of data to nodes B and D. The data flowing from node A to node B is scheduled to pass through nodes E and F. Node A has no way of knowing whether the scheduled transfer through nodes E and F will oversubscribe these nodes. This can lead to a bottleneck forming through nodes E and F, resulting in ineffective use of bandwidth and the potential for dropping data transfers. Transfers from node A to node B could fall behind schedule. Receive bandwidth that node B reserves for receiving data from node A may be wasted when it could have been used for receiving data from node C.

FIG. 5 is a block diagram representing a data transfer though nodes E and F, using virtual nodes VE 120 and VF 122 in accordance with one embodiment of the present invention. Virtual nodes VE and VF carry out scheduling operations for nodes E and F according to the same scheduling process used by nodes A, B, C, and D. Virtual nodes VE and VF also exchange scheduling related information with member nodes A, B, C, and D on behalf of nodes E and F.

Virtual nodes 120 and 122 have information that allows them to mirror the member node scheduling scheme at nodes E and F, respectively. In one implementation, this includes consideration of receive and transmit bandwidth, as well as data storage capacity. In one embodiment, virtual nodes VE and VF receive this information from nodes E and F. In another embodiment, virtual nodes VE and VF are programmed with this information, based on empirical data gathered from monitoring the operation of nodes E and F.

In one implementation, virtual nodes VE and VF communicate with non-member nodes E and F. This allows nodes E and F to receive data transfer scheduling instructions from virtual nodes VE and VF—enabling nodes E and F to transfer data in accordance with the same scheme as the member nodes. In an alternate embodiment, virtual nodes VE and VF do not provide scheduling information to nodes E and F. In such an embodiment, virtual nodes VE and VF can only inform member nodes of whether nodes E and F have sufficient resources to take part in a requested data transfer.

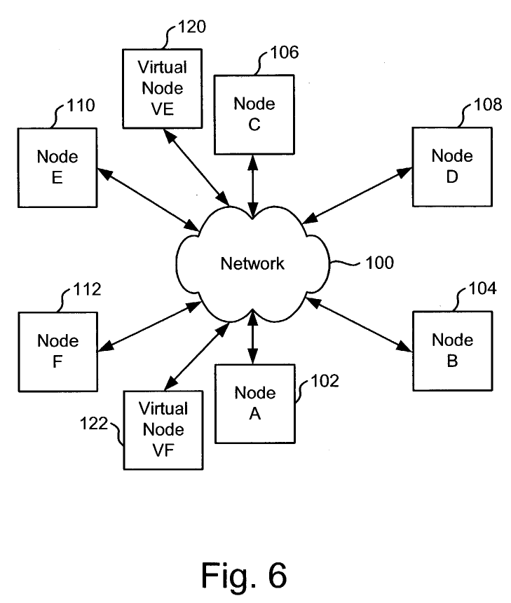

FIG. 6 shows that virtual nodes VE and VF reside on systems that are coupled to network 100 and physically separate from nodes E and F. In one implementation, one computer system can support multiple virtual nodes, while in other embodiments each virtual node is on a separate computer system. In further embodiments, virtual nodes VE and VF operate on the same computer system as a member node that already shares scheduling communications, such as nodes A, B, C, and D.

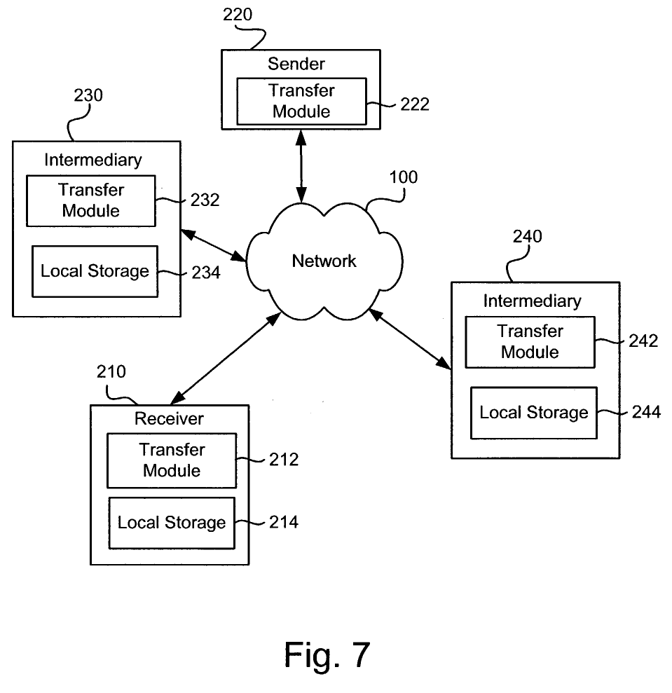

FIG. 7 is a block diagram of network nodes operating in different roles according to one embodiment of the present invention. Any node can receive data, send data, or act as an intermediary that passes data from one node to another. In fact, a node may be supporting all or some of these functions simultaneously. In embodiments including virtual nodes, a non-member node that does not exchange scheduling communications operates in tandem with a virtual node to perform receiver, sender, and intermediary functions.

Network 100 connects receiver node 210, sender node 220, and intermediary nodes 230 and 240. In this example, sender 220 is transferring data to receiver 210 through intermediaries 230 and 240. The data can include a variety of information such as text, graphics, video, and audio. Receiver 210 is a computing device, such as a personal computer, set-top box, or Internet appliance, and includes transfer module 212 and local storage 214. Sender 220 is a computing device, such as a web server or other appropriate electronic networking device, and includes transfer module 222. In further embodiments, sender 220 also includes local storage. Intermediaries 230 and 240 are computing devices, such as servers, and include transfer modules 232 and 242 and local storages 234 and 244, respectively.

Transfer modules 212, 222, 232, and 242 facilitate the scheduling of data transfers in accordance with the present invention. In the case of a virtual node, the transfer module for a non-member node that does not exchange scheduling communications is maintained on the virtual node. As shown earlier in FIG. 5, the virtual node can share the required scheduling information with the non-member node in certain embodiments.

The transfer module at each node evaluates a data transfer request in view of satisfying various objectives. Example objectives include meeting a deadline for completion of the transfer, minimizing the cost of bandwidth, a combination of these two objectives, or any other appropriate objectives. In one embodiment, a transfer module evaluates a data transfer request using known and estimated bandwidths at each node and known and estimated storage space at receiver 210 and intermediaries 230 and 240. A transfer module may also be responsive to a priority assigned to a data transfer. Greater detail regarding transfer module scheduling operations appears below.

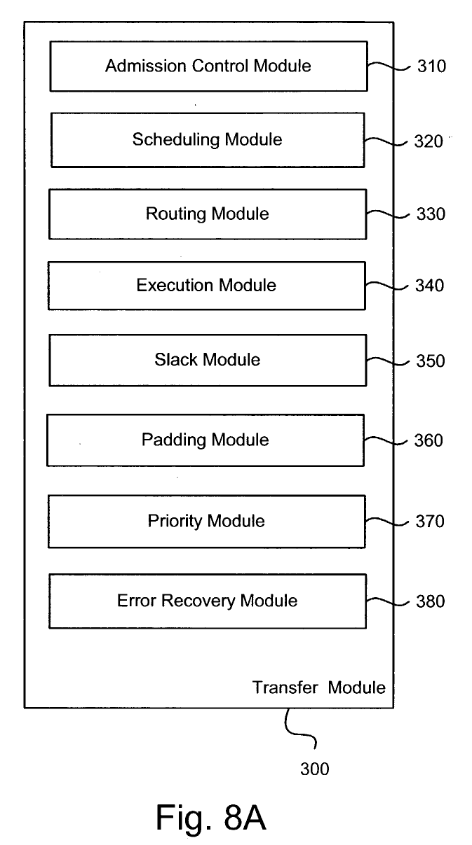

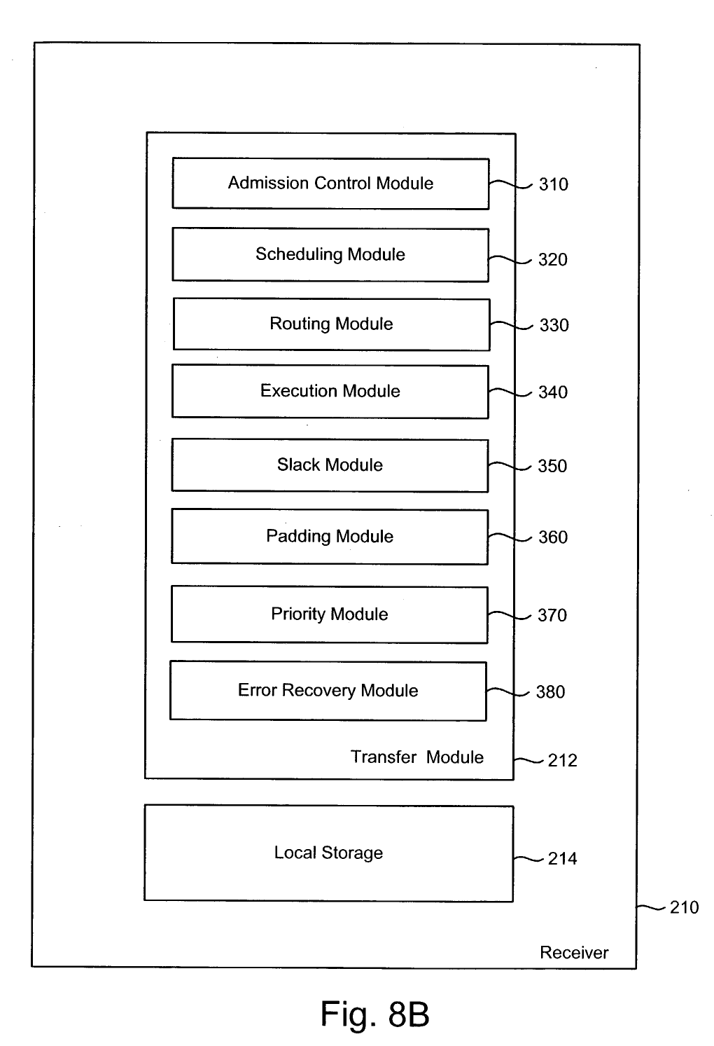

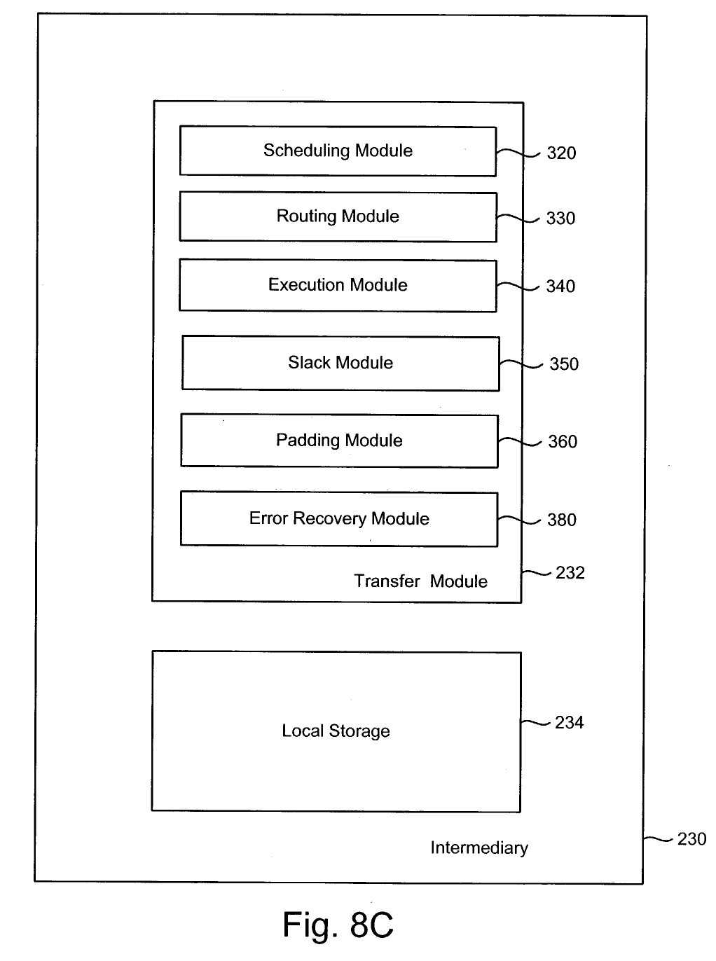

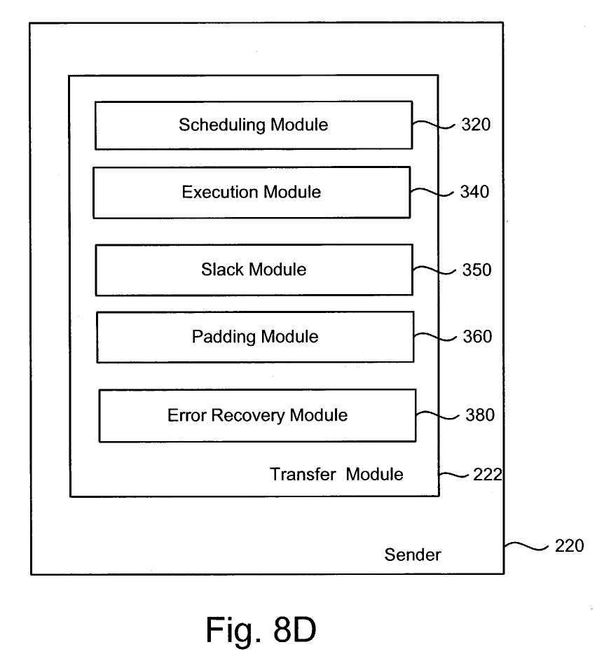

FIGS. 8A-8D are block diagrams of different transfer module configurations employed in embodiments of the present invention. FIG. 8A is a block diagram of one embodiment of a transfer module 300 that can be employed in a receiver, sender, or intermediary. Transfer module 300 includes, but is not limited to, admission control module 310, scheduling module 320, routing module 330, execution module 340, slack module 350, padding module 360, priority module 370, and error recovery module 380.

Admission control module 310 receives user requests for data transfers and determines the feasibility of the requested transfers in conjunction with scheduling module 320 and routing module 330. Admission control module 310 queries routing module 330 to identify possible sources of the requested data. Scheduling module 320 evaluates the feasibility of a transfer from the sources identified by routing module 330 and reports back to admission control module 310.

Execution module 340 manages accepted data transfers and works with other modules to compensate for unexpected events that occur during a data transfer. Execution module 340 operates under the guidance of scheduling module 320, but also responds to dynamic conditions that are not under the control of scheduling module 320.

Slack module 350 determines an amount of available resources that should be uncommitted (reserved) in anticipation of differences between actual (measured) and estimated transmission times. Slack module 350 uses statistical estimates and historical performance data to perform this operation. Padding module 360 uses statistical models to determine how close to deadlines transfer module 300 should attempt to complete transfers.

Priority module 370 determines which transfers should be allowed to preempt other transfers. In various implementations of the present invention, preemption is based on priorities given by users, deadlines, confidence of transfer time estimates, or other appropriate criteria. Error recovery module 380 assures that the operations controlled by transfer module 300 can be returned to a consistent state if an unanticipated event occurs.

Several of the above-described modules in transfer module 300 are optional in different applications. FIG. 8B is a block diagram of one embodiment of transfer module 212 in receiver 210. Transfer module 212 includes, but is not limited to, admission control module 310, scheduling module 320, routing module 330, execution module 340, slack module 350, padding module 360, priority module 370, and error recovery module 380. FIG. 8C is a block diagram of one embodiment of transfer module 232 in intermediary 230. Transfer module 232 includes scheduling module 320, routing module 330, execution module 340, slack module 350, padding module 360, and error recovery module 380. FIG. 8D is a block diagram of one embodiment of transfer module 222 in sender 220. Transfer module 22 includes scheduling module 320, execution module 340, slack module 350, padding module 360, and error recovery module 380.

In alternate embodiments that above-described transfer modules can have many different configurations. Also note that roles of the nodes operating as receiver 210, intermediary 230, and sender 220 can change—requiring their respective transfer modules to adapt their operation for supporting the roles of sender, receiver, and intermediary. For example, in one data transfer a specific computing device acts as intermediary 230 while in another data transfer the same device acts as sender 220.

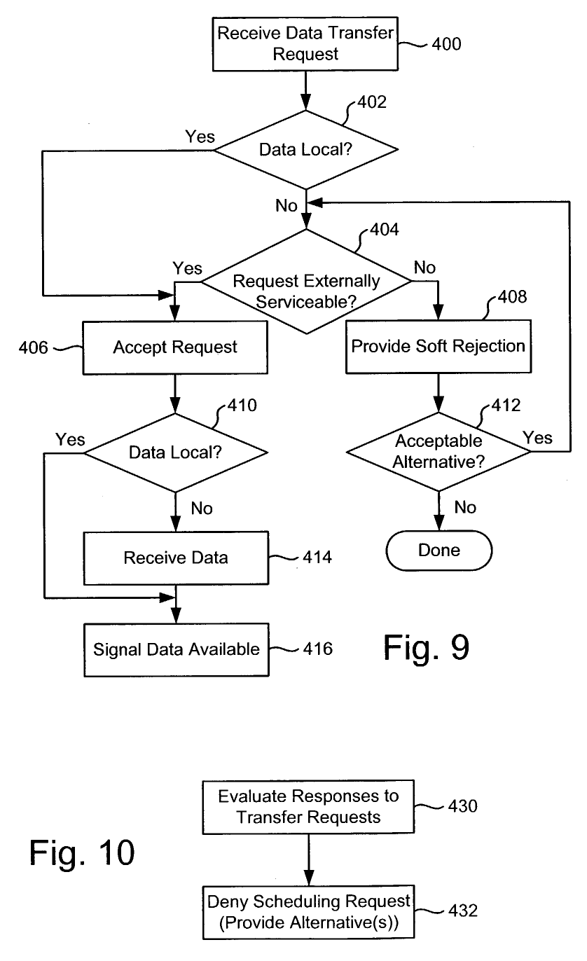

FIG. 9 is a flowchart describing one embodiment of a process employed by transfer module 300 to service user requests for data. Admission control module 310 receives a data transfer request from an end user (step 400) and determines whether the requested data is available in a local storage (step 402). If the data is maintained in the computer system containing transfer module 300, admission control module 310 informs the user that the requested is accepted (406) and the data is available (step 416).

If the requested data is not stored locally (step 402), transfer module 300 determines whether the data request can be serviced externally by receiving a data transfer from another node in network 100 (step 404). If the request can be serviced, admission control module 310 accepts the user's data request (step 406). Since the data is not stored locally (step 410), the node containing transfer module 300 receives the data from an external source (step 414), namely the node in network 100 that indicated it would provide the requested data. The received data satisfies the data transfer request. Once the data is received, admission control module 310 signals the user that the data is available for use.

If the data request cannot be serviced externally (step 404), admission control module 310 provides the user with a soft rejection (408) in one embodiment. In one implementation, the soft rejection suggests a later deadline, higher priority, or a later submission time for the original request. A suggestion for a later deadline is optionally accompanied by an offer of waiting list status for the original deadline. Transfer module 300 determines whether the suggested alternative(s) in the soft rejection is acceptable. In one implementation, transfer module 300 queries the user. If the alternative(s) is acceptable, transfer module 300 once again determines whether the request can be externally serviced under the alternative condition(s) (step 404). Otherwise, the scheduling process is complete and the request will not be serviced. Alternate embodiments of the present invention do not provide for soft rejections.

FIG. 10 is a flowchart describing one embodiment of a process for providing a soft rejection (step 408). After transfer module 300 determines a request cannot be serviced (step 404), transfer module 300 evaluates the rejection responses from the external data sources (step 430). In one embodiment, these responses include soft rejection alternatives that admission control module 300 provides to the user along with a denial of the original data request (step 432). In alternate embodiments, admission control module 310 only provides the user with a subset of the proposed soft rejection alternatives, based on the evaluation of the responses (step 432).

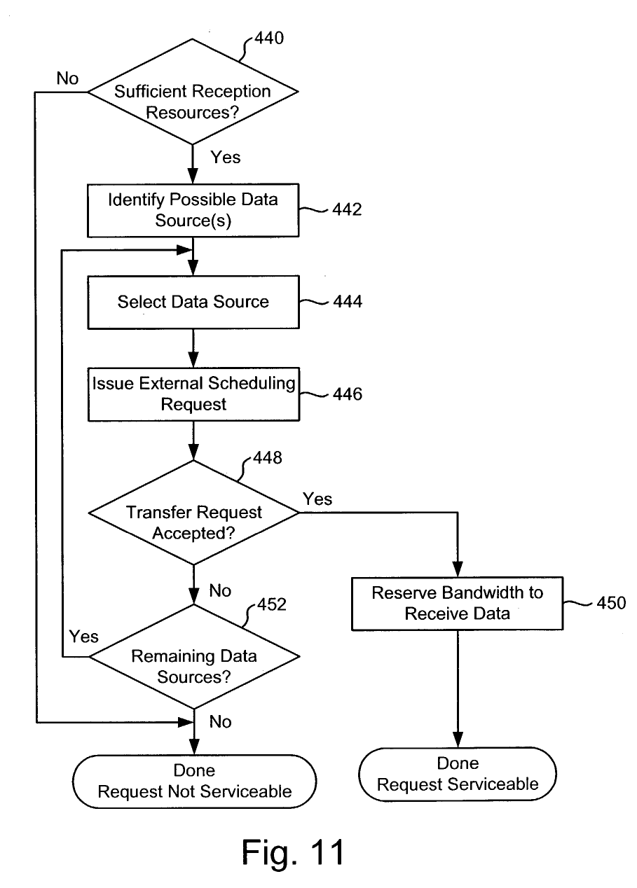

FIG. 11 is a flowchart describing one embodiment of a process for determining whether a data transfer request is serviceable (step 404, FIG. 9). Transfer module 300 determines whether the node requesting the data, referred to as the receiver, has sufficient resources for receiving the data (step 440). In one embodiment, this includes determining whether the receiver has sufficient data storage capacity and bandwidth for receiving the requested data (step 440). If the receiver's resources are insufficient, the determination is made that the request is not serviceable (step 440).

If the receiver has sufficient resources (step 440), routing module 330 identifies the potential data sources for sending the requested data to the receiver (step 442). In one embodiment, routing module 330 maintains a listing of potential data sources. Scheduling module 320 selects an identified data source (step 444) and sends the data source an external scheduling request for the requested data (step 446). In one implementation, the external scheduling request identifies the desired data and a deadline for receiving the data. In further implementations, the scheduling request also defines a required bandwidth schedule that must be satisfied by the data source when transmitting the data.

The data source replies to the scheduling request with an acceptance or a denial. If the scheduling request is accepted, scheduling module 320 reserves bandwidth in the receiver for receiving the data (step 450) and informs admission control module 310 that the data request is serviceable. In the case of a virtual node, transfer module 300 reserves bandwidth (step 450) by instructing the associated non-member node to reserve the bandwidth. In alternate virtual node embodiments, the non-member node cannot be instructed to reserve bandwidth.

If the scheduling request is denied, scheduling module 320 determines whether requests have not yet been sent to any of the potential data sources identified by routing module 330 (step452). If there are remaining data sources, scheduling module 320 selects a new data source (step 444) and sends the new data source an external scheduling request (step 446). Otherwise, scheduling module 320 informs admission control module 310 that the request is not serviceable.

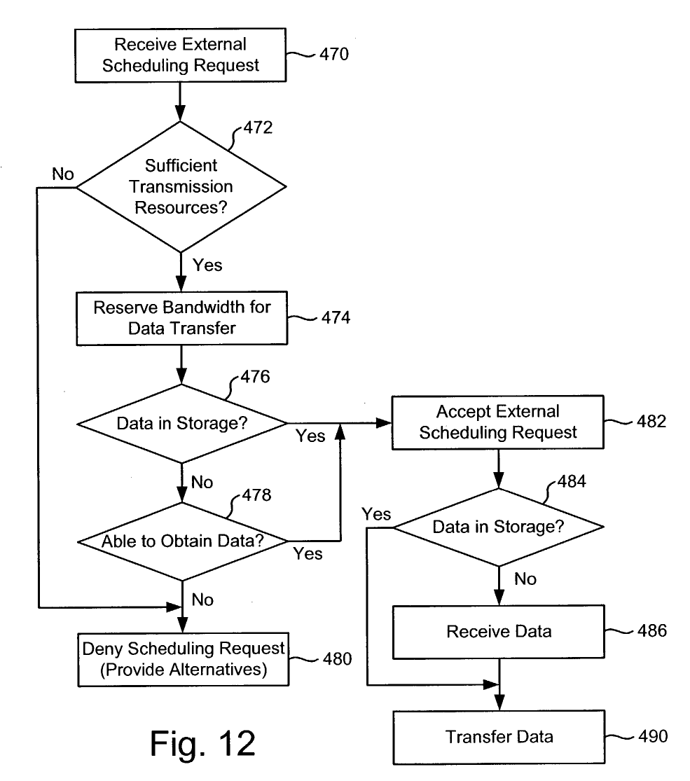

FIG. 12 is a flowchart describing one embodiment of a process for servicing an external scheduling request at a potential data source node, such as sender 220 or intermediary 230 (FIG. 7). Transfer module 300 in the data source receives the scheduling request (step 470). In the case of a virtual node, the data source is considered to be the combination of the virtual node and its associated non-member node. The virtual node receives the scheduling request (step 470), since the virtual node contains transfer module 300.

Transfer module 300 determines whether sufficient transmission resources exist for servicing the request (step 472). In one embodiment, scheduling module 300 in the data source determines whether sufficient bandwidth exists for transmitting the requested data (step 472). If the transmission resources are not sufficient, scheduling module 312 denies the scheduling request (step 480). In embodiments using soft rejections, scheduling module 320 also suggests alternative schedule criteria that could make the request serviceable, such as a later deadline.

If the transmission resources are sufficient (step 472) transfer module 300 reserves bandwidth at the data source for transmitting the requested data to the receiver (step 474). As discussed above, virtual nodes reserve bandwidth by issuing an instruction to an associated non-member node. In some embodiments, bandwidth is not reserved, because the non-member node does not receive instructions from the virtual node.

Transfer module 300 in the data source determines whether the requested data is stored locally (step 476). If the data is stored locally, transfer module 300 informs the receiver that the scheduling request has been accepted (step 482) and transfers the data to the receiver at the desired time (step 490).

If the requested data is not stored locally (step 476), scheduling module 320 in the data source determines whether the data can be obtained from another node (step 478). If the data cannot be obtained, the scheduling request is denied (step 480). Otherwise, transfer module 300 in the data source informs the receiver that the scheduling request is accepted. Since the data is not store locally (step 484), the data source receives the data from another node (step 486) and transfers the data to the receiver at the desired time (step 490).

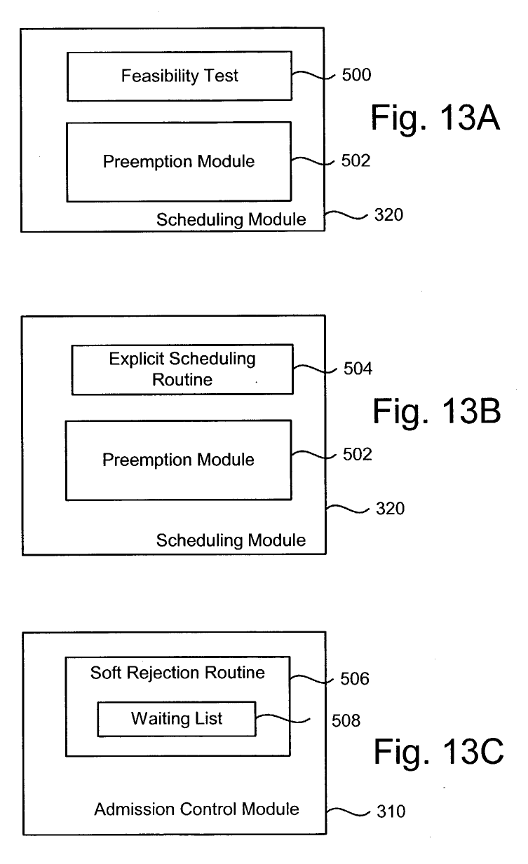

FIG. 13A is a block diagram of scheduling module 320 in one embodiment of the present invention. Scheduling module 320 includes feasibility test module 500 and preemption module 502. Feasibility test module 500 determines whether sufficient transmission bandwidth exists in a sender or intermediary to service a scheduling request (step 472, FIG. 12). In one embodiment, feasibility test module 500 employs the following information: the identities of sender 220 (or intermediary 230) and receiver 210, the size of the file to transfer, a maximum bandwidth receiver 210 can accept, a transmission deadline, and information about available and committed bandwidth resources. A basic function of feasibility test module 500 includes a comparison of the time remaining before the transfer deadline to the size of the file to transfer divided by the available bandwidth. In alternative embodiments, this basic function is augmented by consideration of the total bandwidth that is already committed to other data transfers. Each of the other data transfers considered includes a file size and expected transfer rate used to calculate the amount of the total bandwidth their transfer will require.

Preemption module 502 is employed in embodiments of the invention that support multiple levels of priority for data requests. More details regarding preemption based on priority levels is provided below.

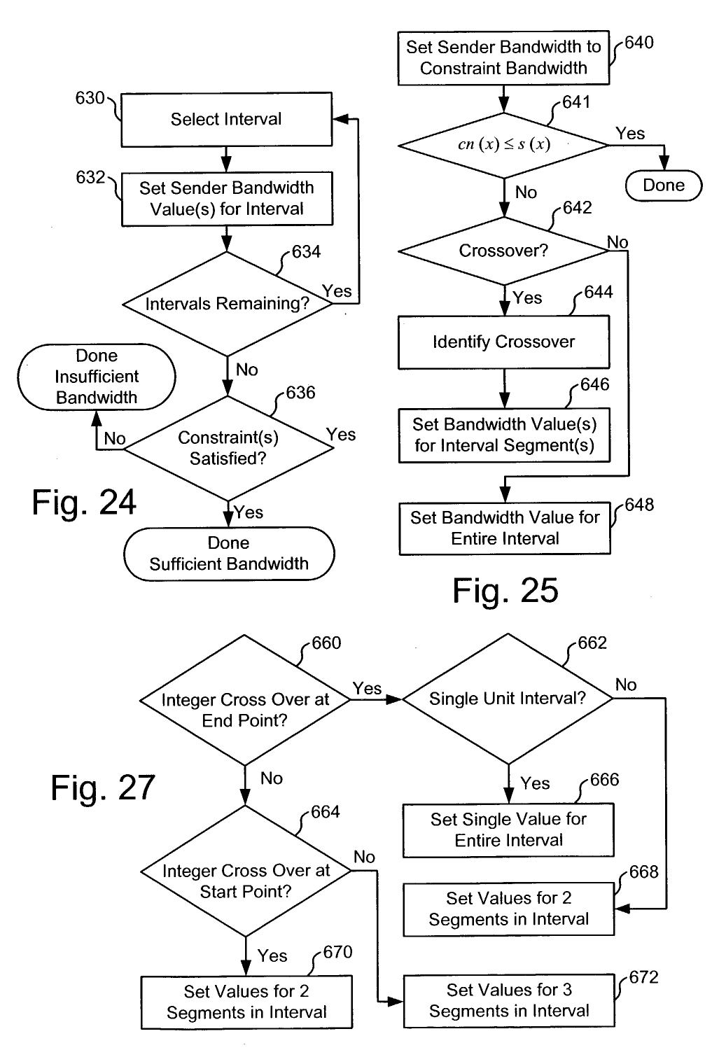

FIG. 13B is a block diagram of scheduling module 320 in an alternate implementation of the present invention. Scheduling module 320 includes explicit scheduling routine module 504 and preemption module 502. Explicit scheduling routine module 504 also determines whether sufficient transmission bandwidth exists in a sender or intermediary to service a scheduling request (step 472, FIG. 12). Explicit scheduling routine module 504 uses a detailed schedule of uncommitted space and bandwidth resources to make the determination. Greater details regarding explicit scheduling are provided below with reference to FIGS. 24-30.

FIG. 13C is a block diagram of admission control module 310 in one implementation of the present invention. Admission control module 310 includes soft rejection routine module 506 to carry out the soft rejection operations explained above with reference to FIGS. 9 and 10. Admission control module 310 also includes waiting list 508 for tracking rejected requests that are waiting for bandwidth to become available.

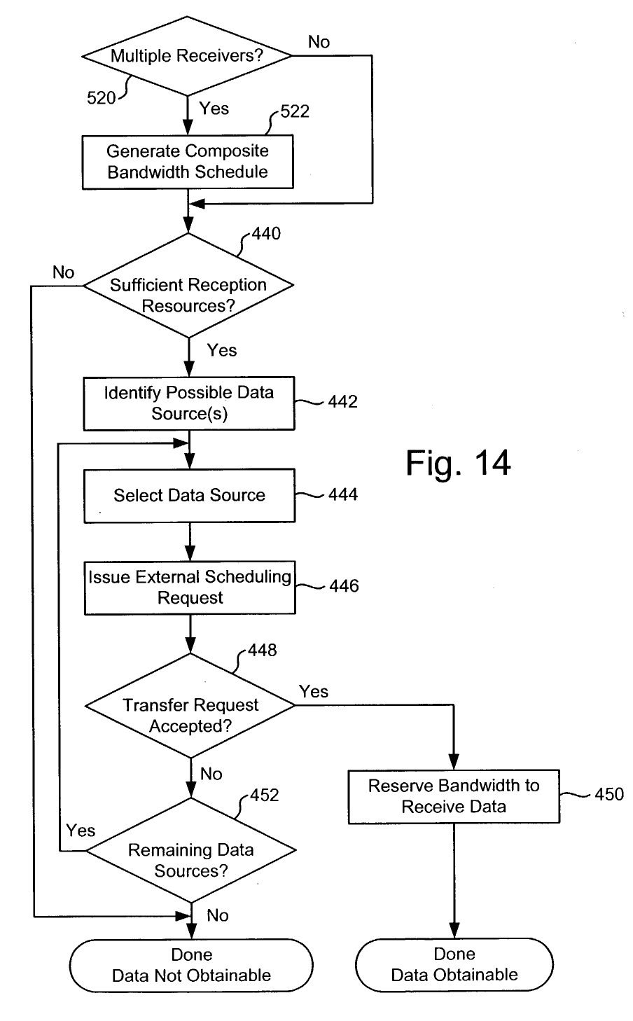

FIG. 14 is a flowchart describing one embodiment of a process for determining whether a node will be able to obtain data called for in a scheduling request (step 478, FIG. 12). The steps bearing the same numbers that appear in FIG. 11 operate the same as described above in FIG. 11 for determining whether data can be retrieved to satisfy a data request.

The difference arising in FIG. 14 is the addition of steps to address the situation where multiple nodes request the same data. As shown in FIG. 3, an intermediary, such as node B, may need to service multiple scheduling requests for the same data. The embodiment shown in FIG. 14 enables node B to issue a scheduling request that calls for a single data transfer from sender node A. The scheduling request calls for data that satisfies the send bandwidth schedules established by node B for transmitting data to nodes C and D (See FIG. 3).

Transfer module 300 in node B determines whether multiple nodes are calling for the delivery of the same data from node B (step 520, FIG. 14). If not, transfer module 300 skips to step 440 and carries out the process as described in FIG. 11. In this implementation, the scheduling request issued in step 446 is based on the bandwidth demand of a single node requesting data from node B.

If node B is attempting to satisfy multiple requests for the same data (step 520), scheduling module 310 in node B generates a composite bandwidth schedule (step 522). After the composite bandwidth schedule is generated, transfer module 300 moves to step 440 and carries on the process as described in FIG. 11. In this implementation, the scheduling request issued in step 446 calls for data that satisfies the composite bandwidth schedule.

The composite bandwidth schedule identifies the bandwidth demands a receiver or intermediary must meet when providing data to node B, so that node B can service multiple requests for the same data. Although FIG. 3 shows node B servicing two requests for the same data, further embodiments of the present invention are not limited to only servicing two requests. The principles for servicing two requests for the same data can be extended to any number of requests for the same data.

In one embodiment, node B issues a scheduling request for the composite bandwidth schedule before issuing any individual scheduling requests for the node C and node D bandwidth schedules. In an alternate embodiment, node B generates a composite bandwidth schedule after a scheduling request has been issued for servicing an individual bandwidth schedule for node C or node D. In this case, transfer module 300 instructs the recipient of the individual bandwidth scheduling request that the request has been cancelled. Alternatively, transfer module 300 receives a response to the individual bandwidth scheduling request and instructs the responding node to free the allocated bandwidth. In yet another embodiment, the composite bandwidth is generated at a data source (sender or intermediary) in response to receiving multiple scheduling requests for the same data.

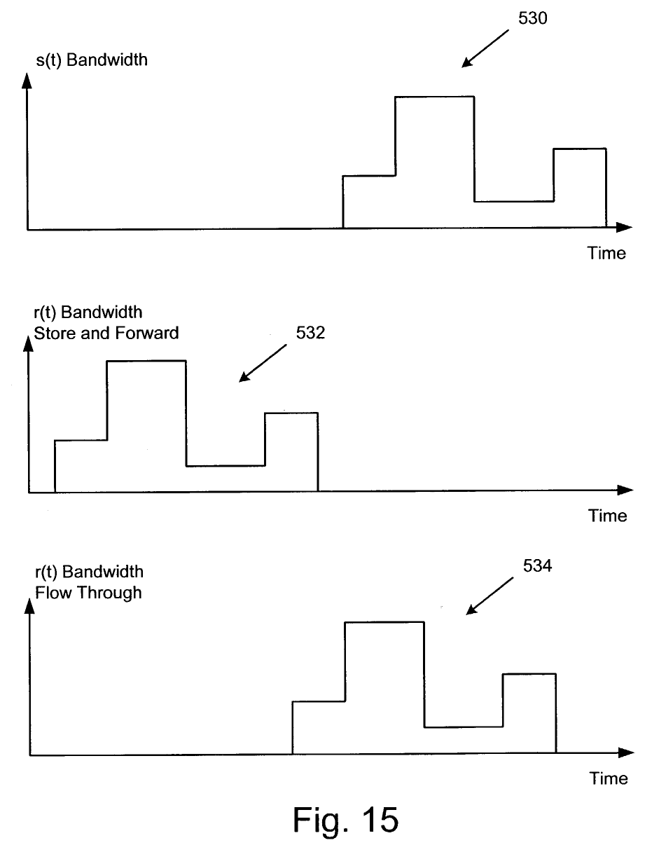

Data transfers can be scheduled as either “store-and-forward” or “flow through” transfers. FIG. 15 employs a set of bandwidth graphs to illustrate the difference between flow through scheduling and store-and-forward scheduling. In one embodiment, a scheduling request includes bandwidth schedule s(t) 530 to identify the bandwidth requirements a sender or intermediary must satisfy over a period of time. In one implementation, this schedule reflects the bandwidth schedule the node issuing the scheduling request will use to transmit the requested data to another node.

Bandwidth schedule r(t) 532 shows a store-and-forward response to the scheduling request associated with bandwidth schedule s(t) 530. In store-and-forward bandwidth schedule 532, all data is delivered to the receiver prior to the beginning of schedule 530. This allows the node that issued the scheduling request with schedule 530 to receive and store all of the data before forwarding it to another entity. In this embodiment, the scheduling request could alternatively identify a single point in time when all data must be received.

Bandwidth schedule r(t) 534 shows a flow through response to the scheduling request associated with bandwidth schedule s(t) 530. In flow through bandwidth schedule 534, all data is delivered to the receiver prior to the completion of schedule 530. Flow through schedule r(t) 534 must always provide a cumulative amount of data greater than or equal to the cumulative amount called for by schedule s(t) 530. This allows the node that issued the scheduling request with schedule s(t) 530 to begin forwarding data to another entity before the node receives all of the data. Greater details regarding the generation of flow through bandwidth schedule r(t) 534 are presented below with reference to FIGS. 24-26.

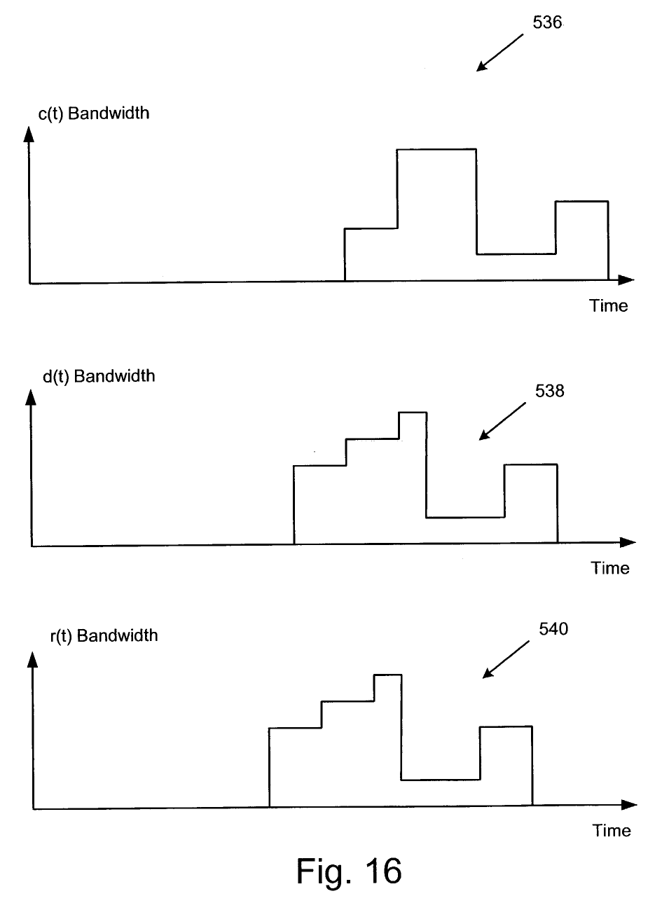

FIG. 16 is a set of bandwidth graphs illustrating one example of flow through scheduling for multiple end nodes in one embodiment of the present invention. Referring back to FIG. 3, bandwidth schedule c(t) represents a schedule node B set for delivering data to node C. Bandwidth schedule d(t) 536 represents a bandwidth schedule node B set for delivering the same data to node D. Bandwidth schedule r(t) 540 represents a flow through schedule node A set for delivering data to node B for servicing schedules c(t) 536 and d(t) 538. In one embodiment of the present invention, node A generates r(t) 540 in response to a composite bandwidth schedule based on schedules c(t) 536 and d(t) 538, as explained above in FIG. 14 (step 522). Although r(t) 540 has the same shape as d(t) 538 in FIG. 16, r(t) 540 may have a shape different than d(t) 538 and c(t) 536 in further examples.

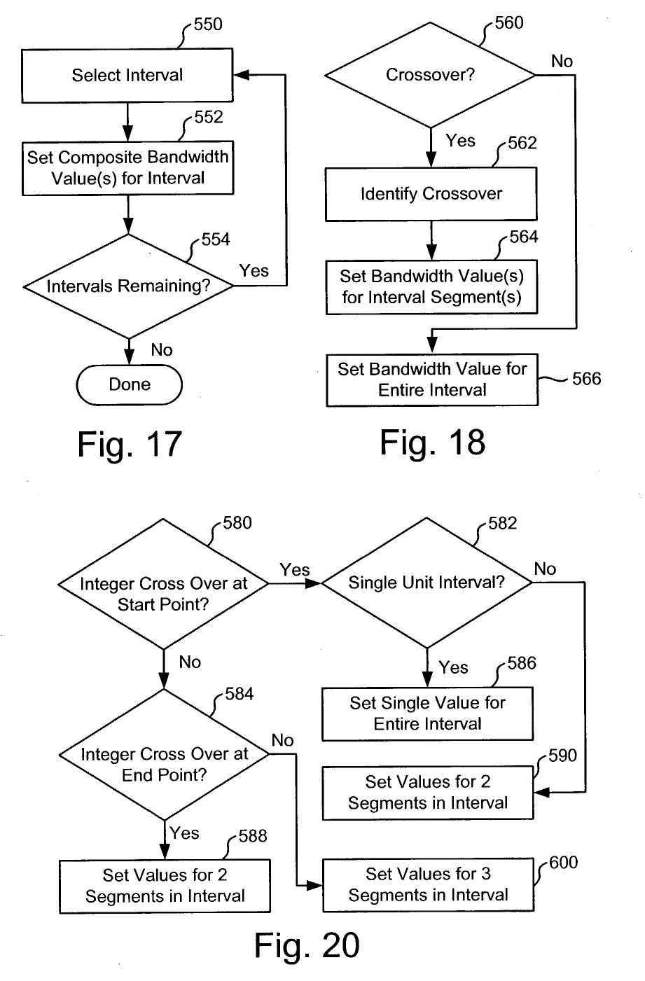

FIG. 17 is a flowchart describing one embodiment of a process for generating a composite bandwidth schedule (step 522, FIG. 14). In this embodiment, bandwidth schedules are generated as step functions. In alternate embodiments, bandwidth schedules can have different formats. Scheduling module 320 selects an interval of time (step 550). For each selected interval, each of the multiple bandwidth schedules for the same data, such as c(t) 536 and d(t) 538, have a constant value (step 550). Scheduling module 320 sets one or more values for the composite bandwidth schedule in the selected interval (step 552). Scheduling module 300 determines whether any intervals remain unselected (step 554). If any intervals remain unselected, scheduling module 320 selects a new interval (step 550) and determines one or more composite bandwidth values for the interval (step 552). Otherwise, the composite bandwidth schedule is complete.

FIG. 18 is a flowchart describing one embodiment of a process for setting composite bandwidth schedule values within an interval (step 552, FIG. 18). The process shown in FIG. 18 is based on servicing two bandwidth schedules, such as c(t) 536 and d(t) 538. In alternate embodiments, additional schedules can be serviced.

The process in FIG. 18 sets values for the composite bandwidth schedule according to the following constraint: the amount of cumulative data called for by the composite bandwidth schedule is never less than the largest amount of cumulative data required by any of the individual bandwidth schedules, such as c(t) 536 and d(t) 538. In one embodiment, the composite bandwidth schedule is generated so that the amount of cumulative data called for by the composite bandwidth schedule is equal to the largest amount of cumulative data required by any of the individual bandwidth schedules. This can be expressed as follows for servicing two individual bandwidth schedules, c(t) 536 and d(t) 538:

$$cb ( t ) = \frac{ⅆ}{ⅆ t} [ max ( C ( t ) , D ( t ) ) ]$$

Wherein:

cb(t) is the composite bandwidth schedule;

t is time;

max ( ) is a function yielding the maximum value in the parentheses;

$$C ( t ) = {\int }_{- ∞}^{t} c ( t ) ⅆ t$$

(representing the cumulative data demanded by bandwidth schedule c(t) 536); and

$$D ( t ) = {\int }_{- ∞}^{t} d ( t ) ⅆ t$$

(representing the cumulative data demanded by bandwidth schedule d(t) 538).

This relationship allows the composite bandwidth schedule cb(t) to correspond to the latest possible data delivery schedule that satisfies both c(t) 536 and d(t) 538.

At some points in time, C(t) may be larger than D(t). At other points in time, D(t) may be larger than C(t). In some instances, D(t) and C(t) may be equal. Scheduling module 320 determines whether there is a data demand crossover within the selected interval (step 560, FIG. 18). A data demand crossover occurs when C(t) and D(t) go from being unequal to being equal or from being equal to being unequal. When this occurs, the graphs of C(t) and D(t) cross at a time in the selected interval.

When a data demand crossover does not occur within a selected interval, scheduling module 320 sets the composite bandwidth schedule to a single value for the entire interval (step 566). If C(t) is larger than D(t) throughout the interval, scheduling module 320 sets the single composite bandwidth value equal to the bandwidth value of c(t) for the interval. If D(t) is larger than C(t) throughout the interval, scheduling module 320 sets the composite bandwidth value equal to the bandwidth value of d(t) for the interval. If C(t) and D(t) are equal throughout the interval, scheduling module 320 sets the composite bandwidth value to the bandwidth value of d(t) or c(t)—they will be equal under this condition.

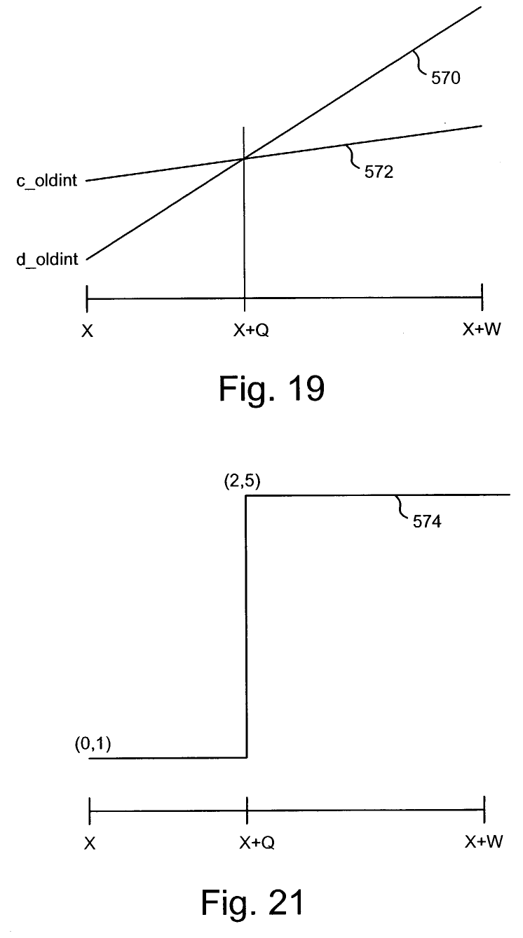

When a data demand crossover does occur within a selected interval, scheduling module 320 identifies the time in the interval when the crossover point of C(t) and D(t) occurs (step 562). FIG. 19 illustrates a data demand crossover point occurring within a selected interval spanning from time x to time x+w. Line 570 represents D(t) and line 572 represents C(t). In the selected interval, D(t) and C(t) cross at time x+Q, where Q is an integer. Alternatively, a crossover may occur at a non-integer point in time.

In one embodiment, scheduling module 320 identifies the time of the crossover point as follows:

Q=INT[(c_oldint−d_oldint)/(d(x)−c(x))]; and

RM=(c_oldint−d_oldint)−Q*(d(x)−c(x))

Wherein:

Q is the integer crossover point;

INT[ ] is a function equal to the integer portion of the value in the brackets;

RM is the remainder from the division that produced Q, where t=x+Q+(RM/(c_oldint−d_oldint)) is the crossing point of D(t) and C(t) within the selected interval;

$$c\_old int = {\int }_{- ∞}^{x} c ( t ) ⅆ t$$

(representing the y-intercept value for line 572);

$$d\_old int = {\int }_{- ∞}^{x} d ( t ) ⅆ t$$

(representing the y-intercept value for line 570);

x is the starting time of the selected interval;

w is the time period of the selected interval;

c(x) is the slope of line 572; and

d(x) is the slope of line 570.

Scheduling module 320 employs the crossover point to set one or more values for the composite bandwidth schedule in the selected interval (step 564).

FIG. 20 is a flowchart describing one embodiment of a process for setting values for the composite bandwidth schedule within a selected interval (step 564, FIG. 18). Scheduling module 320 determines whether the integer portion of the crossover occurs at the start point of the interval—meaning Q equals 0 (step 580). If this is the case, scheduling module 300 determines whether the interval is a single unit long—meaning w equals 1 unit of the time measurement being employed (step 582). In the case of a single unit interval, scheduling module 320 sets a single value for the composite bandwidth within the selected interval (step 586). In one embodiment, this value is set as follows:

For x<=t<x+1: cb(t) equals the slope of the data demand line with the greatest value at the end of the interval less the remainder value RM.

If the interval is not a single unit (step 582), scheduling module 320 sets two values for the composite bandwidth schedule within the selected interval (step 590). In one embodiment, these values are set as follows:

For x<=t<x+1: cb(t) equals the slope of the data demand line with the greatest value at the end of the interval less the remainder value RM; and

For x+1<=t<x+w: cb(t) equals the slope of the data demand line with the greatest value at the end of the interval.

If the integer portion of the crossover does not occurs at the starting point of the interval (step 580), scheduling module 320 determines whether the integer portion of the crossover occurs at the end point of the selected interval=meaning Q>0 and Q+1=w (step 584). If this is the case, scheduling module 320 sets two values for the composite bandwidth schedule within the interval (step 588). In one embodiment, these values are set as follows:

For x<=t<x+Q: cb(t) equals the slope of the data demand line with the lowest value at the end of the interval; and

For x+Q<=t<x+w: cb(t) equals the slope of the data demand line with the greatest value at the end of the interval less the remainder value RM.

If the integer portion of the crossover is not an end point (step 584), scheduling module 320 sets three values for the composite bandwidth schedule in the selected interval (step 600). In one embodiment, these values are set as follows:

For x<=t<x+Q: cb(t) equals the slope of the data demand line with the lowest value at the end of the interval;

For x+Q<=t<x+Q+1: cb(t) equals the slope of the data demand line with the greatest value at the end of the interval less the remainder value RM; and

For x+Q+1<=t<x+w: cb(t) equals the slope of the data demand line with the greatest value at the end of the interval.

By applying the above-described operations, the data demanded by the composite bandwidth schedule during the selected interval equals the total data required for servicing the individual bandwidth schedules, c(t) and d(t). In one embodiment, this results in the data demanded by the composite bandwidth schedule from the beginning of time through the selected interval to equal the largest cumulative amount of data specified by one of the individual bandwidth schedules through the selected interval. In mathematical terms, for the case where a crossover exists between C(t) and D(t) within the selected interval and D(t) is larger than C(t) at the end of the interval:

$${\int }_{x}^{x + w} cb ( t ) ⅆ t = {\int }_{x}^{x + w} d ( t ) ⅆ t - {\int }_{x}^{x + w} c ( t ) ⅆ t$$

FIG. 21 is a graph showing one example of values set for the composite bandwidth schedule in the selected interval in step 600 (FIG. 20) using data demand lines 570 and 572 in FIG. 19. In this example, c_oldint=80, d_oldint=72, x=0, w=5, c(0)=1, and d(0)=5. This results in the following:

Q=INT[(80−72)/(5−1)]=2

RM=(80−72)−2*(5−1)=0

For 0<=t<2: cb(t)=1;

For 2<=t<3: cb(t)=5−0=5; and

For 3<=t<5: cb(t)=5.

Composite bandwidth schedule 574 in FIG. 21 reflects the above-listed value settings in the selected interval.

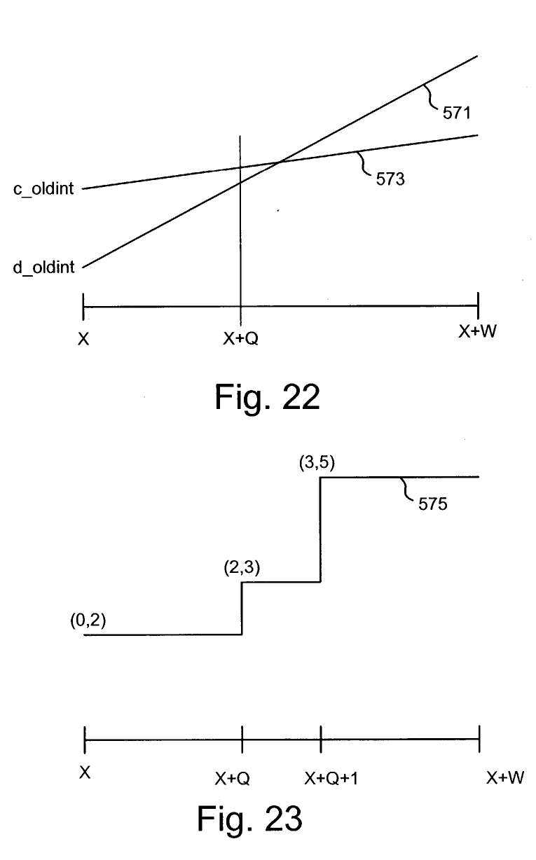

FIG. 22 illustrates a non-integer data demand crossover point occurring within a selected interval spanning from time x to time x+w. Line 571 represents D(t) and line 573 represents C(t). In the selected interval, D(t) and C(t) cross at time x+Q+(RM/(d(x)−c(x)).

FIG. 23 is a graph showing one example of values set for the composite bandwidth schedule in the selected interval in step 600 (FIG. 20) using data demand lines 571 and 573 in FIG. 22. In this example, c_oldint=80, d_oldint=72, x=0, w=5, c(0)=2, and d(0)=5. This results in the following:

Q=INT[(80−72)/(5−2)]=2

RM=(80−72)−2*(5−2)=2

For 0<=t<2: cb(t)=2;

For 2<=t<3: cb(t)=5−2=3; and

For 3<=t<5: cb(t)=5.

FIG. 24 is a flowchart describing one embodiment of a process for determining whether sufficient transmission bandwidth exists at a data source (sender or intermediary) to satisfy a scheduling request (step 472, FIG. 12). In one embodiment, this includes the generation of a send bandwidth schedule r(t) that satisfies the demands of a bandwidth schedule s(t) associated with the scheduling request. In one implementation, as described above, the scheduling request bandwidth schedule s(t) is a composite bandwidth schedule cb(t).

Scheduling module 320 in the data source considers bandwidth schedule s(t) and constraints on the ability of the data source to provide data to the requesting node. One example of such a constraint is limited availability of transmission bandwidth. In one implementation, the constraints can be expressed as a constraint bandwidth schedule cn(t). In this embodiment, bandwidth schedules are generated as step functions. In alternate embodiments, bandwidth schedules can have different formats.

Scheduling module 320 selects an interval of time where bandwidth schedules s(t) and cn(t) have constant values (step 630). In one embodiment, scheduling module 320 begins selecting intervals from the time at the end of scheduling request bandwidth schedule s(t)—referred to herein as s_end. The selected interval begins at time x and extends for all time before time x+w—meaning the selected interval is expressed as x<=t<x+w. In one implementation, scheduling module 320 determines the values for send bandwidth schedule r(t) in the time period x+w<=t<s_end before selecting the interval x<=t<x+w.

Scheduling module 320 sets one or more values for the send bandwidth schedule r(t) in the selected interval (step 632). Scheduling module 300 determines whether any intervals remain unselected (step 634). In one implementation, intervals remain unselected as long the requirements of s(t) have not yet been satisfied and the constraint bandwidth schedule is non-zero for some time not yet selected.

If any intervals remain unselected, scheduling module 320 selects a new interval (step 630) and determines one or more send bandwidth values for the interval (step 632). Otherwise, scheduling module 320 determines whether the send bandwidth schedule meets the requirements of the scheduling request (step 636). In one example, constraint bandwidth schedule cn(t) may prevent the send bandwidth schedule r(t) from satisfying scheduling request bandwidth schedule s(t). If the scheduling request requirements are met (step 636), sufficient bandwidth exists and scheduling module 320 reserves transmission bandwidth (step 474, FIG. 12) corresponding to send bandwidth schedule r(t). Otherwise, scheduling module 320 reports that there is insufficient transmission bandwidth.

FIG. 25 is a flowchart describing one embodiment of a process for setting send bandwidth schedule values within an interval (step 632, FIG. 24). The process shown in FIG. 25 is based on meeting the following conditions: (1) the final send bandwidth schedule r(t) is always less than or equal to constraint bandwidth schedule cn(t); (2) data provided according to the final send bandwidth schedule r(t) is always greater than or equal to data required by scheduling request bandwidth schedule s(t); and (3) the final send bandwidth schedule r(t) is the latest send bandwidth schedule possible, subject to conditions (1) and (2).

For the selected interval, scheduling module 320 initially sets send bandwidth schedule r(t) equal to the constraint bandwidth schedule cn(t) (step 640). Scheduling module 320 then determines whether the value for constraint bandwidth schedule cn(t) is less than or equal to scheduling request bandwidth schedule s(t) within the selected interval (step 641). If so, send bandwidth schedule r(t) remains set to the value of constraint bandwidth schedule cn(t) in the selected interval. Otherwise, scheduling module 320 determines whether a crossover occurs in the selected interval (642).

A crossover may occur within the selected interval between the values R(t) and S(t), as described below:

$$R ( t ) = {\int }_{t}^{x + w} cn ( v ) ⅆ v + {\int }_{x + w}^{s\_end} r ( v ) ⅆ v$$

(representing the accumulated data specified by send bandwidth schedule r(t) as initially set, in a range spanning the beginning of the selected interval through s_end); and

$$S ( t ) = {\int }_{t}^{s\_end} s ( v ) ⅆ v$$

(representing the accumulated data specified by scheduling request bandwidth schedule s(t) in a range spanning the beginning of the selected interval through s_end).

A crossover occurs when the lines defined by R(t) and S(t) cross. When a crossover does not occur within the selected interval, scheduling module 320 sets send bandwidth schedule r(t) to the value of constraint bandwidth schedule cn(t) for the entire interval (step 648).

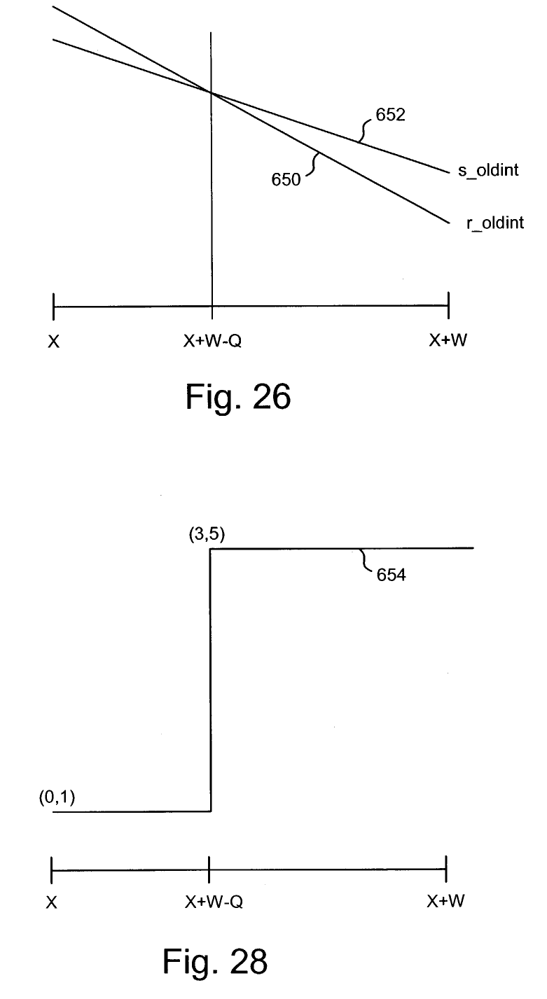

When a crossover does occur within a selected interval, scheduling module 320 identifies the time in the interval when the crossover point occurs (step 644). FIG. 26 illustrates an accumulated data crossover point occurring within a selected interval (x<=t<x+w). Line 650 represents the R(t) that results from initially setting r(t) to cn(t) in step 640 (FIG. 25). Line 652 represents S(t). In the selected interval, R(t) and S(t) cross at time x+w−Q, where Q is an integer. Alternatively, a crossover may occur at a non-integer point in time.

In one embodiment, scheduling module 300 identifies the time of the crossover point as follows:

Q=INT[(s_oldint−r_oldint)/(cn(x)−s(x))]; and

RM=(s_oldint−r_oldint)−Q*(cn(x)−s(x))

Wherein:

Q is the integer crossover point;

RM is the remainder from the division that produced Q, where t=x+w−Q−(RM/(s_oldint−r_oldint)) is the crossing point of R(t) and S(t) within the selected interval;

$$s\_old int = {\int }_{x + w}^{s\_end} s ( t ) ⅆ t$$

(representing the y-intercept value for line 652);

$$r\_old int = {\int }_{x + w}^{s\_end} r ( t ) ⅆ t$$

(representing the y-intercept value for line 650);

x is the starting time of the selected interval;

w is the time period of the selected interval;

−cn(x) is the slope of line 650; and

−s(x) is the slope of line 652.

Scheduling module 320 employs the crossover point to set one or more final values for send bandwidth schedule r(t) in the selected interval (step 646, FIG. 25).

FIG. 27 is a flowchart describing one embodiment of a process for setting final values for send bandwidth schedule r(t) within a selected interval (step 646, FIG. 25). Scheduling module 320 determines whether the integer portion of the crossover occurs at the end point of the interval—meaning Q equals 0 (step 660). If this is the case, scheduling module 320 determines whether the interval is a single unit long—meaning w equals 1 unit of the time measurement being employed (step 662). In the case of a single unit interval, scheduling module 320 sets a single value for send bandwidth schedule r(t) within the selected interval (step 666). In one embodiment, this value is set as follows:

For x<=t<x+w: r(t) equals the sum of the absolute value of the slope of accumulated data line S(t) and the remainder value RM—meaning r(t)=s(x)+RM.

If the interval is not a single unit (step 662), scheduling module 320 sets two values for send bandwidth schedule r(t) within the selected interval (step 668). In one embodiment, these values are set as follows:

For x<=t<x+w−1: r(t) equals the absolute value of the slope of accumulated data line S(t)—meaning r(t)=s(x); and

For x+w−1<=t<x+w: r(t) equals the sum of the absolute value of the slope of accumulated data line S(t) and the remainder value RM—meaning r(t)=s(x)+RM.

If the integer portion of the crossover does not occurs at the end point of the interval (step 660), scheduling module 320 determines whether the integer portion of the crossover occurs at the start point of the selected interval—meaning Q>0 and Q+1=w (step 664). If this is the case, scheduling module 320 sets two values for send bandwidth schedule r(t) within the selected interval (step 670). In one embodiment, these values are set as follows:

For x<=t<x+1: r(t) equals the sum of the absolute value of the slope of accumulated data line S(t) and the remainder value RM—meaning r(t)=s(x)+RM; and

For x+1<=t<x+w: r(t) equals the constraint bandwidth schedule—meaning r(t)=cn(x).

If the integer portion of the crossover is not a start point (step 664), scheduling module 320 sets three values for send bandwidth schedule r(t) in the selected interval (step 670). In one embodiment, these values are set as follows:

For x<=t<x+w−Q−1: r(t) equals the absolute value of the slope of accumulated data line S(t)—meaning r(t)=s(x);

For x+w−Q−1<=t<x+w−Q: r(t) equals the sum of the absolute value of the slope of accumulated data line S(t) and the remainder value RM—meaning r(t)=s(x)+RM; and

For x+w−Q<=t<x+w: r(t) equals the constraint bandwidth schedule—meaning r(t)=cn(x).

By applying the above-described operations, send bandwidth schedule r(t) provides data that satisfies scheduling request bandwidth schedule s(t) as late as possible. In one embodiment, where cn(t)>s(t) for a selected interval, the above-described operations result in the cumulative amount of data specified by r(t) from s_end through the start of the selected interval (x) to equal the cumulative amount of data specified by s(t) from s_end through the start of the selected interval (x).

FIG. 28 is a graph showing one example of values set for the send bandwidth schedule in the selected interval in step 672 (FIG. 27) using accumulated data lines 652 and 650 in FIG. 26. In this example, s_oldint=80, r_oldint=72, x=0, w=5, s(x)=1, and cn(x)=5. This results in the following:

Q=INT[(80−72)/(5−1)]=2

RM=(80−72)−2*(5−1)=0

For 0<=t<2: r(t)=1;

For 2<=t<3: r(t)=1+0=1; and

For 3<=t<5: r(t)=5.

Send bandwidth schedule 654 in FIG. 28 reflects the above-listed value settings in the selected interval.

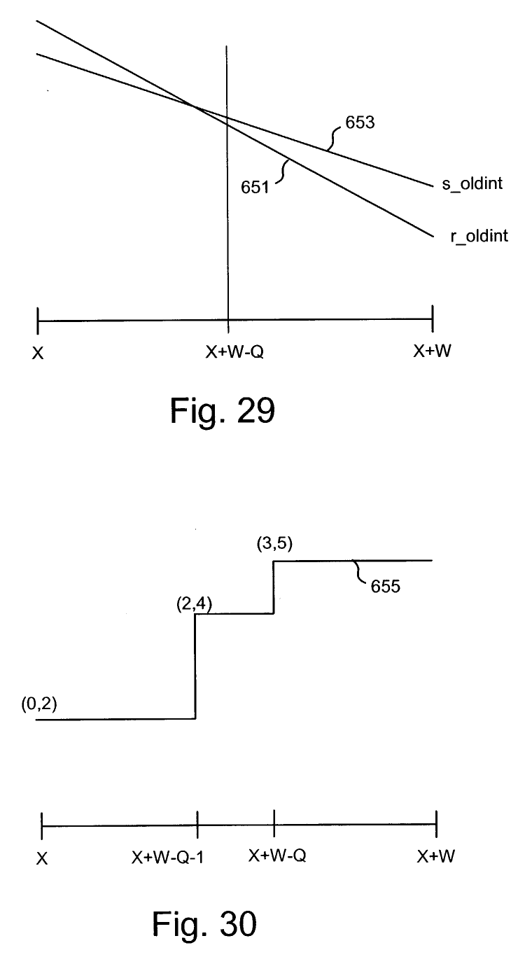

FIG. 29 illustrates a non-integer data demand crossover point occurring within a selected interval spanning from time x to time x+w. Line 653 represents S(t) and line 651 represents R(t) with the initial setting of r(t) to cn(t) in the selected interval. In the selected interval, S(t) and R(t) cross at time x+w−Q−(RM/(cn(x)−s(x)).

FIG. 30 is a graph showing one example of values set for send bandwidth schedule r(t) in the selected interval in step 672 (FIG. 207) using accumulated data lines 653 and 651 in FIG. 29. In this example, s_oldint=80, r_oldint=72, x=0, w=5, cn(x)=5, and s(x)=2. This results in the following:

Q=INT[(80−72)/(5−2)]=2

RM=(80−72)−2*(5−2)=2

For 0<=t<2: r(t)=2;

For 2<=t<3: r(t)=2+2=4; and

For 3<=t<5: r(t)=5.

Some embodiments of the present invention employ forward and reverse proxies. A forward proxy is recognized by a node that desires data from a data source as a preferable alternate source for the data. If the node has a forward proxy for desired data, the node first attempts to retrieve the data from the forward proxy. A reverse proxy is identified by a data source in response to a scheduling request as an alternate source for requested data. After receiving the reverse proxy, the requesting node attempts to retrieve the requested data from the reverse proxy instead of the original data source. A node maintains a redirection table that correlates forward and reverse proxies to data sources, effectively converting reverse proxies into forward proxies for later use. Using the redirection table avoids the need to receive the same reverse proxy multiple times from a data source.

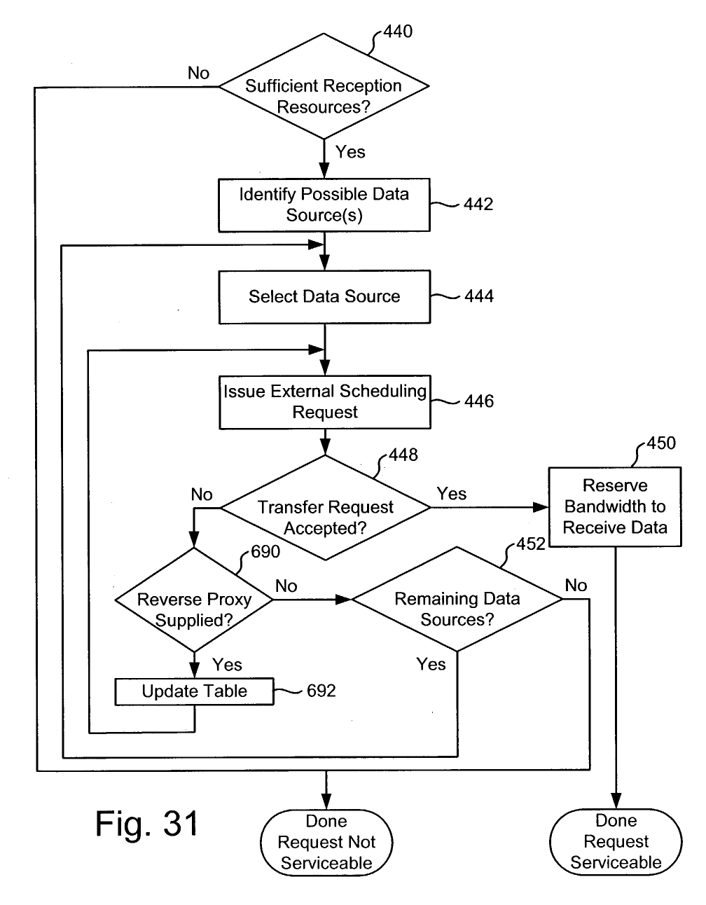

FIG. 31 is a flowchart describing an alternate embodiment of a process for determining whether a data transfer request is serviceable, using proxies. The steps with the same numbers used in FIGS. 11 and 14 operate as described above with reference to FIGS. 11 and 14. In further embodiments, the process shown in FIG. 31 also includes the steps shown in FIG. 14 for generating a composite bandwidth schedule for multiple requests.

In order to handle proxies, the process in FIG. 31 includes the step of determining whether a reverse proxy is supplied (step 690) when an external scheduling is denied (step 448). If a reverse proxy is not supplied, transfer module 300 determines whether there are any remaining data sources (step 452). Otherwise, transfer module 300 updates the node's redirection table with the reverse proxy (step 692) and issues a new scheduling request to the reverse proxy for the desired data (step 446). In one embodiment, the redirection table update (step 692) includes listing the reverse proxy as a forward proxy for the node that returned the reverse proxy.

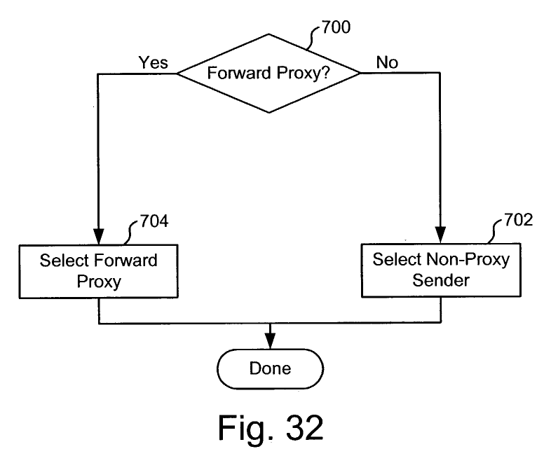

FIG. 32 is a flowchart describing one embodiment of a process for selecting a data source (step 444, FIGS. 11, 14, and 31), using proxies. Transfer module 300 determines whether there are any forward proxies associated with the desired data that have not yet been selected (step 700). If so, transfer module 300 selects one of the forward proxies as the desired data source (step 704). In one embodiment, transfer module 300 employs the redirection table to identify forward proxies. In one such embodiment, the redirection table identifies a data source and any forward proxies associated with the data source for the requested data. If no forward proxies are found, transfer module 300 selects a non-proxy data source as the desired sender (step 702).

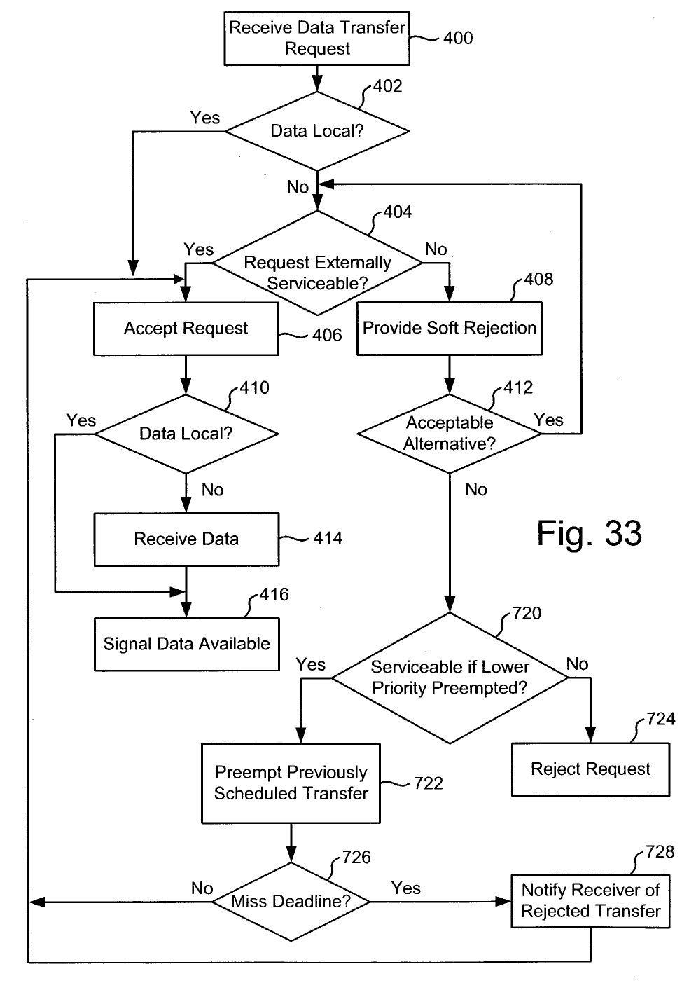

FIG. 33 is a flowchart describing an alternate embodiment of a process for servicing data transfer requests when preemption is allowed. The steps with the same numbers used in FIG. 9 operate as described above with reference to FIG. 9. Once a data request has been rendered unserviceable (step 412), transfer module 300 determines whether the request could be serviced by preempting a transfer from a lower priority request (step 720).

Priority module 370 (FIG. 8A) is included in embodiments of transfer module 300 that support multiple priority levels. In one embodiment, priority module 370 uses the following information to determination whether preemption is warranted (step 720): (1) information about a request (requesting node, source node, file size, deadline), (2) information about levels of service available at the requesting node and the source node, (3) additional information about cost of bandwidth, and (4) a requested priority level for the data transfer. In further embodiments, additional or alternate information can be employed.

If preemption of a lower priority transfer will not allow a request to be serviced (step 720), the request is finally rejected (step 724). Otherwise, transfer module 300 preempts a previously scheduled transfer so the current request can be serviced (step 722). In one embodiment, preemption module 502 (FIGS. 13A and 13B) finds lower priority requests that have been accepted and whose allocated resources are relevant to the current higher priority request. The current request then utilizes the bandwidth and other resources formerly allocated to the lower priority request. In one implementation, a preemption results in the previously scheduled transfer being cancelled. In alternate implementations, the previously scheduled transfer is rescheduled to a later time.

Transfer module 300 determines whether the preemption causes a previously accepted request to miss a deadline (step 726). Fox example, the preemption may cause a preempted data transfer to fall outside a specified window of time. If so, transfer module 300 notifies the data recipient of the delay (step 728). In either case, transfer module 300 accepts the higher priority data transfer request (step 406) and proceeds as described above with reference to FIG. 9.

In further embodiments, transfer module 300 instructs receiver scheduling module 320 to poll source nodes of accepted transfers to update their status. Source node scheduling module 320 replies with an OK message (no change in status), a DELAYED message (transfer delayed by some time), or a CANCELED message.

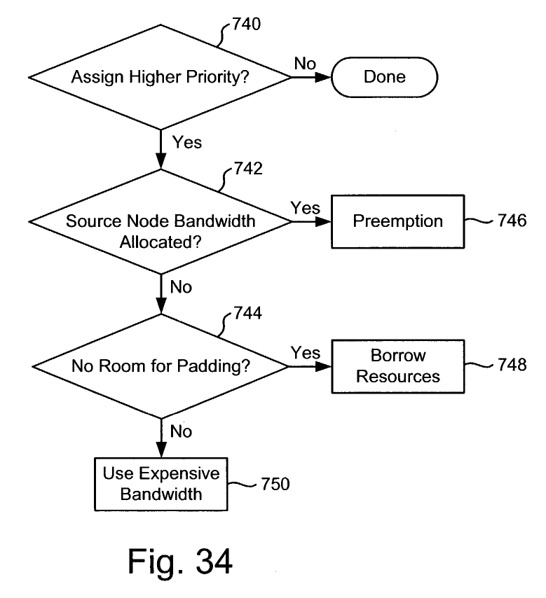

FIG. 34 is a flowchart describing one embodiment of a process for servicing data transfer requests in an environment that supports multiple priority levels. All or some of this process may be incorporated in step 404 and/or step 720 (FIG. 33) in further embodiments of the present invention. Priority module 370 (FIG. 8A) determines whether the current request is assigned a higher priority than any of the previous requests (step 740). In one embodiment, transfer module 300 queries a user to determine whether the current request's priority should be increased to allow for preemption. For example, priority module 370 gives a user requesting a data transfer an option of paying a higher price to assign a higher priority to the transfer. If the user accepts this option, the request has a higher priority and has a greater chance of being accepted.

If the assigned priority of the current request is not higher than any of the scheduled transfers (step 740), preemption is not available. Otherwise, priority module 370 determines whether the current request was rejected because all transmit bandwidth at the source node was already allocated (step 742). If so, preemption module 502 preempts one or more previously accepted transfers from the source node (step 746). If not, priority module 370 determines whether the current request was rejected because there was no room for padding (step 744). If so, preemption module 502 borrows resources from other transfers at the time of execution in order to meet the deadline. If not, preemption module 502 employs expensive bandwidth that is available to requests with the priority level of the current request (step 750). In some instances, the available bandwidth may still be insufficient.

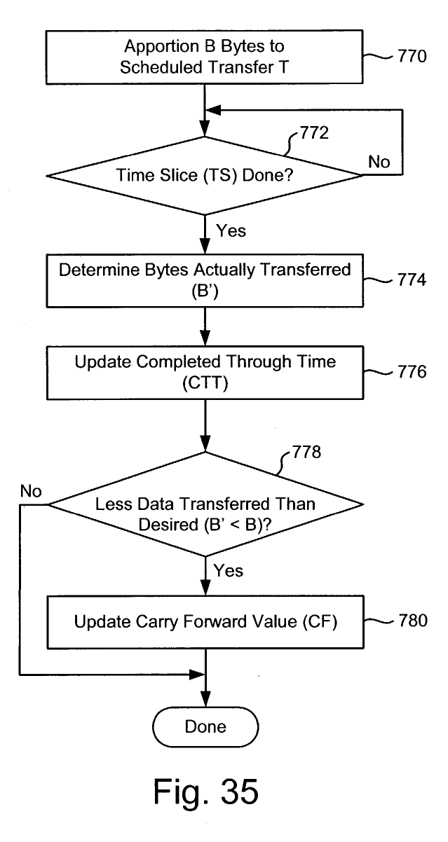

FIG. 35 is a flowchart describing one embodiment of a process for tracking the use of allocated bandwidth. When scheduling module 320 uses explicit scheduling routine 504, the apportionment of available bandwidth to a scheduled transfer depends upon the details of the above-described bandwidth schedules. In one embodiment, a completed through time (CTT) is associated with a scheduled transfer T. CTT serves as a pointer into the bandwidth schedule transfer T.

For a time slice of length TS, execution module 330 apportions B bytes to transfer T (step 770), where B is the integral of the bandwidth schedule from CTT to CTT+TS. After detecting the end of time slice TS (step 772), execution module 340 determines the number of bytes actually transferred, namely B′ (step 774). Execution module 340 then updates CTT to a new value, namely CTT′ (step 776), where the integral from CTT to CTT′ is B′.

At the end of time slice TS, execution module 340 determines whether the B′ amount of data actually transferred is less than the scheduled B amount of data (step 778). If so, execution module 340 updates a carry forward value CF to a new value CF′, where CF′=CF+B−B′. Otherwise, CF is not updated. The carry forward value keeps track of how many scheduled bytes have not been transferred.

Any bandwidth not apportioned to other scheduled transfers can be used to reduce the carry forward. Execution module 340 also keeps track of which scheduled transfers have been started or aborted. Transfers may not start as scheduled either because space is not available at a receiver or because the data is not available at a sender. Bandwidth planned for use in other transfers that have not started or been aborted is also available for apportionment to reduce the carry forward.

As seen from FIG. 35, execution module 340 is involved in carrying out a node's scheduled transfers. In one embodiment, every instance of transfer module 300 includes execution module 340, which uses information stored at each node to manage data transfers. This information includes a list of accepted node-to-node transfer requests, as well as information about resource reservations committed by scheduling module 320.

Execution module 340 is responsible for transferring data at the scheduled rates. Given a set of accepted requests and a time interval, execution module 340 selects the data and data rates to employ during the time interval. In one embodiment, execution module 340 uses methods as disclosed in the co-pending application entitled “System and Method for Controlling Data Transfer Rates on a Network.”

The operation of execution module 340 is responsive to the operation of scheduling module 320. For example, if scheduling module 320 constructs explicit schedules, execution module 340 attempts to carry out the scheduled data transfers as close as possible to the schedules. Alternatively, execution module 340 performs data transfers as early as possible, including ahead of schedule. If scheduling module 320 uses feasibility test module 502 to accept data transfer request, execution module 340 uses the results of those tests to prioritize the accepted requests.

As shown in FIG. 35, execution module 340 operates in discrete time slice intervals of length TS. During any time slice, execution module 340 determines how much data from each pending request should be transferred from a sender to a receiver. Execution module 340 determines the rate at which the transfer should occur by dividing the amount of data to be sent by the length of the time slice TS. If scheduling module 320 uses explicit scheduling routine 504, there are a number of scheduled transfers planned to be in progress during any time slice. There may also be transfers that were scheduled to complete before the current time slice, but which are running behind schedule. In further embodiments, there may be a number of dynamic requests receiving service, and a number of dynamic requests pending.

Execution module 340 on each sender apportions the available transmit bandwidth among all of these competing transfers. In some implementations, each sender attempts to send the amount of data for each transfer determined by this apportionment. Similarly, execution module 340 on each receiver may apportion the available receive bandwidth among all the competing transfers. In some implementations, receivers control data transfer rates. In these implementations, the desired data transfer rates are set based on the amount of data apportioned to each receiver by execution module 340 and the length of the time slice TS.

In other implementations, both a sender and receiver have some control over the transfer. In these implementations, the sender attempts to send the amount of data apportioned to each transfer by its execution module 340. The actual amount of data that can be sent, however, may be restricted either by rate control at a receiver or by explicit messages from the receiver giving an upper bound on how much data a receiver will accept from each transfer.

Execution module 340 uses a dynamic request protocol to execute data transfers ahead of schedule. One embodiment of the dynamic request protocol has the following four message types:

DREQ(id, start, rlimit, Dt);

DGR(id, rlimit);

DEND_RCV(id, size); and

DEND_XMIT(id, size, Dt).

DREQ(id, start, rlimit, Dt) is a message from a receiver to a sender calling for the sender to deliver as much as possible of a scheduled transfer identified by id. The DREQ specifies for the delivery to be between times start and start+Dt at a rate less than or equal to rlimit. The receiver reserves rlimit bandwidth during the time interval from start to start+Dt for use by this DREQ. The product of the reserved bandwidth, rlimit, and the time interval, Dt, must be greater than or equal to a minimum data size BLOCK. The value of start is optionally restricted to values between the current time and a fixed amount of time in the future. The DREQ expires if the receiver does not get a data or message response from the sender by time start+Dt.

DGR(id, rlimit) is a message from a sender to a receiver to acknowledge a DREQ message. DGR notifies the receiver that the sender intends to transfer the requested data at a rate that is less than or equal to rlimit. The value of rlimit used in the DGR command must be less than or equal to the rlimit of the corresponding DREQ.

DEND_RCV(id, size) is a message from a receiver to a sender to inform the sender to stop sending data requested by a DREQ message with the same id. DEND also indicates that the receiver has received size bytes.

DEND_XMIT(id, size, Dt) is a message from a sender to a receiver to signal that the sender has stopped sending data requested by a DREQ message with the same id, and that size bytes have been sent. The message also instructs the receiver not to make another DREQ request to the sender until Dt time has passed. In one implementation, the message DEND_XMIT(id, 0, Dt) is used as a negative acknowledgment of a DREQ.

A transfer in progress and initiated by a DREQ message cannot be preempted by another DREQ message in the middle of a transmission of the minimum data size BLOCK. Resource reservations for data transfers are canceled when the scheduled data transfers are completed prior to their scheduled transfer time. The reservation cancellation is done each time the transfer of a BLOCK of data is completed.

If a receiver has excess receive bandwidth available, the receiver can send a DREQ message to a sender associated with a scheduled transfer that is not in progress. Transfers not in progress and with the earliest start time are given the highest priority. In systems that include time varying cost functions for bandwidth, the highest priority transfer not in progress is optionally the one for which moving bandwidth consumption from the scheduled time to the present will provide the greatest cost savings. The receiver does not send a DREQ message unless it has space available to hold the result of the DREQ message until its expected use (i.e. the deadline of the scheduled transfer).

If a sender has transmit bandwidth available, and has received several DREQ messages requesting data transfer bandwidth, the highest priority DREQ message corresponds to the scheduled transfer that has the earliest start time. The priority of DREQ messages for transfers to intermediate local storages is optionally higher than direct transfers. Completing these transfers early will enable the completion of other data transfers from an intermediary in response to DREQ messages. While sending the first BLOCK of data for some DREQ, the sender updates its transmit schedule and then re-computes the priorities of all pending DREQ's. Similarly, a receiver can update its receive schedule and re-compute the priorities of all scheduled transfers not in progress.

In one embodiment of the present invention, transfer module 300 accounts for transmission rate variations when reserving resources. Slack module 350 (FIG. 8A) reserves resources at a node in a data transfer path. Slack module 350 reserves resource based on the total available resources on each node involved in a data transfer and historical information about resource demand as a function of time. The amount of excess resources reserved is optionally based on statistical models of the historical information.

In one embodiment slack module 350 reserves a fixed percentage of all bandwidth resources (e.g. 20%). In an alternative embodiment, slack module 350 reserves a larger fraction of bandwidth resources at times when transfers have historically run behind schedule (e.g., between 2 and 5 PM on weekdays). The reserved fraction of bandwidth is optionally spread uniformly throughout each hour, or alternatively concentrated in small time intervals (e.g., 1 minute out of each 5 minute time period).

In one implementation, transfer module 300 further guards against transmission rate variations by padding bandwidth reserved for data transfers. Padding module 360 (FIG. 8A) in transfer module 300 determines an amount of padding time P. Transfer module 300 adds padding time P to an estimated data transfer time before scheduling module 320 qualifies a requested data transfer as acceptable. Padding time P is chosen such that the probability of completing the transfer before a deadline is above a specified value. In one embodiment, padding module 360 determines padding time based on the identities of the sender and receiver, a size of the data to be transferred, a maximum bandwidth expected for the transfer, and historical information about achieved transfer rates.

In one embodiment of padding module 360, P is set as follows:

P=MAX[MIN_PAD, PAD_FRACTION*ST]

Wherein:

MAX [ ] is a function yielding the maximum value within the brackets;

ST is the scheduled transfer time; and

MIN_PAD and PAD_FRACTION are constants

In one implementation MIN_PAD is 15 minutes, and PAD_FRACTION is 0.25. In alternative embodiments, MIN_PAD and PAD_FRACTION are varied as functions of time of day, sender-receiver pairs, or historical data. For example, when a scheduled transfer spans a 2 PM-5 PM interval, MIN_PAD may be increased by 30 minutes.

In another embodiment, P is set as follows:

P=ABS_PAD+FRAC_PAD_TIME

Wherein:

ABS_PAD is a fixed time (e.g., 5 seconds);

FRAC_PAD_TIME is the time required to transfer B bytes;

B=PAD_FRACTION*SIZE; and

SIZE is the size of the requested data file.

In this embodiment, available bandwidth is taken into account when FRAC_PAD_TIME is computed from B.

In further embodiments, transfer module 300 employs error recovery module 380 (FIG. 8A) to manage recovery from transfer errors. If a network failure occurs, connections drop, data transfers halt, and/or schedule negotiations timeout. Error recovery module 380 maintains a persistent state at each node, and the node uses that state to restart after a failure. Error recovery module 380 also minimizes (1) the amount of extra data transferred in completing interrupted transfers and (2) the number of accepted requests that are canceled as a result of failures and timeouts.

In one implementation, data is stored in each node to facilitate restarting data transfers. Examples of this data includes data regarding requests accepted by scheduling module 320, resource allocation, the state of each transfer in progress, waiting lists 508 (if these are supported), and any state required to describe routing policies (e.g., proxy lists).

Error recovery module 380 maintains a persistent state in an incremental manner. For example, data stored by error recovery module 380 is updated each time one of the following events occurs: (1) a new request is accepted; (2) an old request is preempted or; (3) a DREQ transfers data of size BLOCK. The persistent state data is reduced at regular intervals by eliminating all requests and DREQs for transfers that have already been completed or have deadlines in the past.

In one embodiment, the persistent state for each sender includes the following: (1) a description of the allocated transmit bandwidth for each accepted request and (2) a summary of each transmission completed in response to a DREQ. The persistent state for each receiver includes the following: (1) a description of the allocated receive bandwidth and allocated space for each accepted request and (2) a summary of each data transfer completed in response to a DREQ.

Although many of the embodiments discussed above describe a distributed system, a centrally controlled system is within the scope of the invention. In one embodiment, a central control node, such as a server, includes transfer module 300. In the central control node, transfer module 300 evaluates each request for data transfers between nodes in communication network 100. Transfer module 300 in the central control node also manages the execution of scheduled data transfers and dynamic requests.

Transfer module 300 in the central control node periodically interrogates (polls) each node to ascertain the node's resources, such as bandwidth and storage space. Transfer module 300 then uses this information to determine whether a data transfer request should be accepted or denied. In this embodiment, transfer module 300 in the central control node includes software required to schedule and execute data transfers. This allows the amount of software needed at the other nodes in communications network 100 to be smaller than in fully distributed embodiments. In another embodiment, multiple central control devices are implemented in communications network 100.

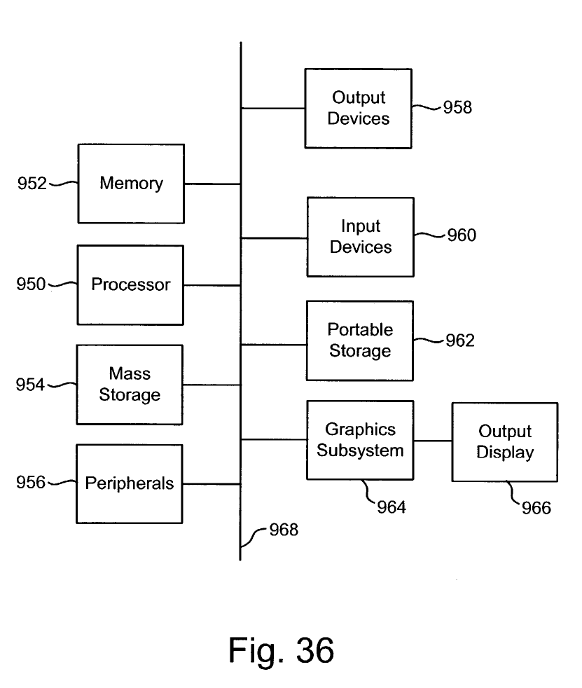

FIG. 36 illustrates a high level block diagram of a computer system that can be used for the components of the present invention. The computer system in FIG. 36 includes processor unit 950 and main memory 952. Processor unit 950 may contain a single microprocessor, or may contain a plurality of microprocessors for configuring the computer system as a multi-processor system. Main memory 952 stores, in part, instructions and data for execution by processor unit 950. If the system of the present invention is wholly or partially implemented in software, main memory 952 can store the executable code when in operation. Main memory 952 may include banks of dynamic random access memory (DRAM) as well as high speed cache memory.

The system of FIG. 36 further includes mass storage device 954, peripheral device(s) 956, user input device(s) 960, portable storage medium drive(s) 962, graphics subsystem 964, and output display 966. For purposes of simplicity, the components shown in FIG. 36 are depicted as being connected via a single bus 968. However, the components may be connected through one or more data transport means. For example, processor unit 950 and main memory 952 may be connected via a local microprocessor bus, and the mass storage device 954, peripheral device(s) 956, portable storage medium drive(s) 962, and graphics subsystem 964 may be connected via one or more input/output (I/O) buses. Mass storage device 954, which may be implemented with a magnetic disk drive or an optical disk drive, is a non-volatile storage device for storing data and instructions for use by processor unit 950. In one embodiment, mass storage device 954 stores the system software for implementing the present invention for purposes of loading to main memory 952.

Portable storage medium drive 962 operates in conjunction with a portable non-volatile storage medium, such as a floppy disk, to input and output data and code to and from the computer system of FIG. 36. In one embodiment, the system software for implementing the present invention is stored on such a portable medium, and is input to the computer system via the portable storage medium drive 962. Peripheral device(s) 956 may include any type of computer support device, such as an input/output (I/O) interface, to add additional functionality to the computer system. For example, peripheral device(s) 956 may include a network interface for connecting the computer system to a network, a modem, a router, etc.

User input device(s) 960 provide a portion of a user interface. User input device(s) 960 may include an alpha-numeric keypad for inputting alpha-numeric and other information, or a pointing device, such as a mouse, a trackball, stylus, or cursor direction keys. In order to display textual and graphical information, the computer system of FIG. 36 includes graphics subsystem 964 and output display 966. Output display 966 may include a cathode ray tube (CRT) display, liquid crystal display (LCD) or other suitable display device. Graphics subsystem 964 receives textual and graphical information, and processes the information for output to display 966. Additionally, the system of FIG. 36 includes output devices 958. Examples of suitable output devices include speakers, printers, network interfaces, monitors, etc.

The components contained in the computer system of FIG. 36 are those typically found in computer systems suitable for use with the present invention, and are intended to represent a broad category of such computer components that are well known in the art. Thus, the computer system of FIG. 36 can be a personal computer, handheld computing device, Internet-enabled telephone, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

I claim:

1. A method for scheduling a transfer in a communications network, said method comprising the steps of:
(a) receiving a scheduling request at a first node for a transfer of data from a second node for a third node; and
(b) determining, at said first node, whether sufficient resources exist at said second node for transmitting said data.

2. A method according to claim 1, wherein said first node is a virtual node corresponding to said second node, wherein said first node stores information about said second node corresponding to resource available at said second node.

3. A method according to claim 2, wherein said information includes data storage available at said second node and bandwidth available at said second node.

4. A method according to claim 3, wherein said bandwidth includes receive bandwidth and transmit bandwidth.

5. A method according to claim 1, wherein said step (b) includes the step of:
(1) generating, at said first node, a send bandwidth schedule that said second node can employ to transfer said data.

6. A method according to claim 5, wherein said send bandwidth schedule is generated in said step (b)(1), based, at least in part, on at least one constraint associated with said second node and a scheduling request bandwidth schedule associated with said scheduling request.

7. A method according to claim 6, wherein said at least one constraint includes a constraint bandwidth schedule.

8. A method according to claim 7, wherein said constraint bandwidth schedule specifies a limit on transferring data.

9. A method according to claim 5, wherein said method further includes the step of:
(c) said first node instructing said second node to reserve bandwidth for transmitting said data according to said send bandwidth schedule.

10. A method according to claim 1, wherein said method further includes the step of:
(d) determining, at said first node, whether said second node is able to obtain said data.

11. A method according to claim 10, wherein said step (d) includes the step of:
(1) said first node issuing a second scheduling request for a data source to transfer said data to said second node.

12. A method according to claim 11, wherein said data source has a corresponding second virtual node and said method further includes the step of:
(e) said second virtual node receiving said second scheduling request.

13. A method according to claim 12, wherein said method further includes the steps of:
(f) said second virtual node generating a second send bandwidth schedule for said data source to provide said data to said second node; and
(g) said data source transmitting said data to said second node.

14. A method according to claim 13, wherein said data source transmits said data according to said second send bandwidth schedule generated by said second virtual node.

15. A method according to claim 11, wherein said second scheduling request is issued to a proxy.

16. A method according to claim 15, wherein said proxy is a forward proxy associated with said data source.

17. A method according to claim 15, wherein said proxy is a reverse proxy associated with said data source.

18. A method according to claim 11, wherein said step (d) further includes the steps of:
(2) receiving a reverse proxy from said data source;
(3) updating a redirection table based on said reverse proxy; and
(4) issuing a third scheduling request to said reverse proxy for said data to be transferred to said second node.

19. A method according to claim 11, wherein said step (d) further includes the steps of:
(2) receiving a reverse proxy from a second virtual node corresponding to said data source;
(3) updating a redirection table based on said reverse proxy; and
(4) issuing a third scheduling request to said reverse proxy for said data to be transferred to said second node.

20. A method according to claim 11, wherein said step (d) further includes the step of:
(5) determining, at said first node, whether sufficient resources exist at said second node for receiving said data.

21. A method according to claim 20, wherein said step (d) further includes the step of:
(6) receiving, at said first node, an acceptance of said second scheduling request.

22. A method according to claim 21, wherein said step (d) further includes the step of:
(7) said first node instructing said second node to reserve bandwidth for receiving said data.

23. A method according to claim 11, wherein said step (d) further includes the step of:
(8) receiving, at said first node, a rejection to said second scheduling request; and
(9) determining, at said first node, whether a lower priority request can be preempted to accommodate said second scheduling request.

24. A method according to claim 1, wherein said method further includes the step of:
(h) said first node informing said third node that said scheduling request is accepted.

25. A method according to claim 24, wherein said method further includes the step of:
(j) said first node informing said third node to reserve bandwidth for receiving said data.

26. A method according to claim 25, wherein said method further includes the step of:
(k) reserving bandwidth at said third node for receiving said data in response to said step (j); and
(l) receiving said data.

27. A method according to claim 1, wherein said method further includes the step of:
(m) transmitting said data from said second node according to a bandwidth schedule generated by said first node.

28. One or more processor readable storage devices having processor readable code embodied on said processor readable storage devices, said processor readable code for programming one or more processors to perform a method for scheduling a transfer in a communications network, said method comprising the steps of:
(a) receiving a scheduling request at a first node for a transfer of data from a second node for a third node; and
(b) determining, at said first node, whether sufficient resources exist at said second node for transmitting said data.

29. One or more processor readable storage devices according to claim 28, wherein said first node is a virtual node corresponding to said second node, wherein said first node stores information about said second node corresponding to resource available at said second node.

30. One or more processor readable storage devices according to claim 29, wherein said information includes data storage available at said second node and bandwidth available at said second node.

31. One or more processor readable storage devices according to claim 30, wherein said bandwidth includes receive bandwidth and transmit bandwidth.

32. One or more processor readable storage devices according to claim 28, wherein said step (b) includes the step of:
(1) generating, at said first node, a send bandwidth schedule that said second node can employ to transfer said data.

33. One or more processor readable storage devices according to claim 32, wherein said send bandwidth schedule is generated in said step (b)(1), based, at least in part, on at least one constraint associated with said second node and a scheduling request bandwidth schedule associated with said scheduling request.

34. One or more processor readable storage devices according to claim 33, wherein said at least one constraint includes a constraint bandwidth schedule.

35. One or more processor readable storage devices according to claim 32, wherein said method further includes the step of:
(c) said first node instructing said second node to reserve bandwidth for transmitting said data according to said send bandwidth schedule.

36. One or more processor readable storage devices according to claim 28, wherein said method further includes the step of:
(d) determining, at said first node, whether said second node is able to obtain said data.

37. One or more processor readable storage devices according to claim 36, wherein said step (d) includes the step of:
(1) said first node issuing a second scheduling request for a data source to transfer said data to said second node.

38. One or more processor readable storage devices according to claim 37, wherein said data source has a corresponding second virtual node.

39. One or more processor readable storage devices according to claim 37, wherein said second scheduling request is issued to a proxy.

40. One or more processor readable storage devices according to claim 37, wherein said step (d) further includes the steps of:
(2) receiving a reverse proxy from said data source;
(3) updating a redirection table based on said reverse proxy; and
(4) issuing a third scheduling request to said reverse proxy for said data to be transferred to said second node.

41. One or more processor readable storage devices according to claim 37, wherein said step (d) further includes the steps of:
(2) receiving a reverse proxy from a second virtual node corresponding to said data source;
(3) updating a redirection table based on said reverse proxy; and
(4) issuing a third scheduling request to said reverse proxy for said data to be transferred to said second node.

42. One or more processor readable storage devices according to claim 37, wherein said step (d) further includes the step of:
(5) determining, at said first node, whether sufficient resources exist at said second node for receiving said data.

43. One or more processor readable storage devices according to claim 42, wherein said step (d) further includes the step of:
(6) receiving, at said first node, an acceptance of said second scheduling request.

44. One or more processor readable storage devices according to claim 43, wherein said step (d) further includes the step of:
(7) said first node instructing said second node to reserve bandwidth for receiving said data.

45. One or more processor readable storage devices according to claim 37, wherein said step (d) further includes the step of:
(8) receiving, at said first node, a rejection to said second scheduling request; and
(9) determining, at said first node, whether a lower priority request can be preempted to accommodate said second scheduling request.

46. One or more processor readable storage devices according to claim 28, wherein said method further includes the step of:
(e) said first node informing said third node that said scheduling request is accepted.

47. One or more processor readable storage devices according to claim 46, wherein said method further includes the step of:
(f) said first node informing said third node to reserve bandwidth for receiving said data.

48. An apparatus comprising:
one or more communications interfaces;
one or more storage devices; and
one or more processors in communication with said one or more storage devices and said one or more communication interfaces, said one or more processors perform a method for scheduling a transfer in a communications network, said method comprising the steps of:
(a) receiving a scheduling request at a first node for a transfer of data from a second node for a third node; and
(b) determining, at said first node, whether sufficient resources exist at said second node for transmitting said data.

49. An apparatus according to claim 48, wherein said first node is a virtual node corresponding to said second node, wherein said first node stores information about said second node corresponding to resource available at said second node.

50. An apparatus according to claim 48, wherein said step (b) includes the step of:
(1) generating, at said first node, a send bandwidth schedule that said second node can employ to transfer said data.

51. An apparatus according to claim 50, wherein said send bandwidth schedule is generated in said step (b)(1), based, at least in part, on at least one constraint associated with said second node and a scheduling request bandwidth schedule associated with said scheduling request.

52. An apparatus according to claim 50, wherein said method further includes the step of:
(c) said first node instructing said second node to reserve bandwidth for transmitting said data according to said send bandwidth schedule.

53. An apparatus according to claim 48, wherein said method further includes the step of:
(d) determining, at said first node, whether said second node is able to obtain said data.

54. An apparatus according to claim 53, wherein said step (d) includes the step of:
(1) said first node issuing a second scheduling request for a data source to transfer said data to said second node.

55. An apparatus according to claim 54, wherein said second scheduling request is issued to a proxy.

56. An apparatus according to claim 54, wherein said step (d) further includes the steps of:
(2) receiving a reverse proxy from said data source;
(3) updating a redirection table based on said reverse proxy; and
(4) issuing a third scheduling request to said reverse proxy for said data to be transferred to said second node.

57. An apparatus according to claim 54, wherein said step (d) further includes the steps of:
(2) receiving a reverse proxy from a second virtual node corresponding to said data source;
(3) updating a redirection table based on said reverse proxy; and
(4) issuing a third scheduling request to said reverse proxy for said data to be transferred to said second node.

58. An apparatus according to claim 54, wherein said step (d) further includes the step of:
(5) determining, at said first node, whether sufficient resources exist at said second node for receiving said data.

59. An apparatus according to claim 58, wherein said step (d) further includes the steps of:
(6) receiving, at said first node, an acceptance of said second scheduling request; and
(7) said first node instructing said second node to reserve bandwidth for receiving said data.

60. An apparatus according to claim 54, wherein said step (d) further includes the step of:
(8) receiving, at said first node, a rejection to said second scheduling request; and
(9) determining, at said first node, whether a lower priority request can be preempted to accommodate said second scheduling request.

61. An apparatus according to claim 48, wherein said method further includes the step of:
(e) said first node informing said third node that said scheduling request is accepted.

62. An apparatus according to claim 61, wherein said method further includes the step of:
(f) said first node informing said third node to reserve bandwidth for receiving said data.

63. A method for scheduling a transfer in a communications network, said method comprising the steps of:
(a) a first node issuing a scheduling request for a second node to transfer data to a third node, wherein said first node is a virtual node corresponding to said third node; and
(b) receiving said data at said third node.
